(19) United States
(12) Patent Application Publication
(10) Pub. No.: US 2021/0351401 A1
(43) Pub. Date: Nov. 11, 2021

(54) POROUS CARBON FIBER ELECTRODES, METHODS OF MAKING THEREOF, AND USES THEREOF

(71) Applicant: VIRGINIA TECH INTELLECTUAL PROPERTIES, INC., Blacksburg, VA (US)

(72) Inventors: Guoliang LIU, Blacksburg, VA (US); Tianyu LIU, Blacksburg, VA (US)

(21) Appl. No.: 17/273,718

(22) PCT Filed: Sep. 6, 2019
(86) PCT No.: PCT/US2019/050035

§ 371 Date: Mar. 4, 2021

Related U.S. Application Data
(60) Provisional application No. 62/727,740, filed on Sep. 6, 2018.
(60) Provisional application No. 62/791,498, filed on Jan. 11, 2019.

(51) Int. Cl. H01M 4/36; H01M 4/86; H01M 4/88; H01M 4/96; H01M 4/04; H01M 4/133; H01M 4/1393; H01M 4/583; H01G 11/24; H01G 11/40; H01G 11/26; H01G 11/86

(52) U.S. Cl. CPC H01M 4/366; H01M 4/8605; H01M 4/8657; H01M 4/88; H01M 4/96; H01M 4/0471; H01M 2004/021; H01M 4/1393; H01M 4/583; H01G 11/24; H01G 11/40; H01G 11/26; H01G 11/86; H01M 4/133

(57) ABSTRACT

Porous carbon fiber electrode materials are provided having fast electron and ion transport. The porous carbon fiber electrodes include uniform mesoscale pores that are partially filled with a metal oxide layer. With large mass loadings of metal oxide, porous carbon fiber electrodes described herein can outperform conventional metal oxide electrodes at similar loadings. In various aspects, electrode materials are provided having (i) a porous carbon fiber support with a plurality of mesoscale pores having an internal surface and an average pore width of about 2 mm to about 200 mm; and (ii) a metal oxide layer on at least the internal surface of the mesoscale pores. Methods of making the porous carbon fiber electrode materials are also provided. Using a microphase-separation of block copolymers, the methods can provide porous carbon fiber supports with interconnected and uniform mesoscale pores that can be deposited with a metal oxide layer.

### CROSS-REFERENCE TO RELATED APPLICATIONS

This application claims priority to, and the benefit of, co-pending U.S. provisional application entitled “MANGANESE DIOXIDE COATED BLOCK COPOLYMER-DERIVED POROUS CARBON FIBER COMPOSITES WITH UNIFORM MESOPORES, HIGH MASS LOADING AND ULTRAFAST ELECTRON AND ION TRANSPORT” having Ser. No. 62/727,740, filed Sep. 6, 2018 (Attorney Docket No. 222204-8380) and co-pending U.S. provisional application entitled “BLOCK COPOLYMER DERIVED UNIFORM MESOPORES ENABLE HIGH MASS LOADING AND ULTRAFAST ELECTRON AND ION TRANSPORT” having Ser. No. 62/791,498, filed Jan. 11, 2019 (Attorney Docket No. 222204-8490), the contents of both of which are incorporated by reference in their entirety.

### STATEMENT REGARDING FEDERALLY SPONSORED RESEARCH OR DEVELOPMENT

This invention was made with government support under award FA9550-17-1-0112 awarded by the United States Air Force, Air Force Office of Scientific Research. The government has certain rights in the invention.

### TECHNICAL FIELD

The present disclosure generally relates to carbon fiber materials and electrodes.

### BACKGROUND

High mass loading and fast charge transport are at the heart of electrochemical energy storage.¹⁻³ The former is important for high energy per device, and the latter for high power.⁴ Unfortunately, high mass loading and fast charge transport are often mutually exclusive characteristics of pseudocapacitors. Low-cost, high-capacitance, and environment-benign pseudocapacitive MnO₂ are loaded on electrically conductive supports and used as supercapacitor electrodes with a theoretical limit of 1367 F g⁻¹ (based on a potential window of 0.8 V).⁵⁻⁹ Toward commercialization, the mass loading of the total active materials must be at least 5 mg cm⁻².¹⁰ However, high mass loadings often lead to thick and dense layers of insulating MnO₂ (10⁻⁵˜10⁻⁶ S cm⁻¹) on the supports.¹¹⁻¹⁴ The high mass loadings on conventional carbon supports lead to sluggish electron conduction and ion diffusion due to the thick pseudocapacitive layer and clogged pores. Consequently, the internal resistance increases and the ion diffusion is perturbed, resulting in sluggish charge transport-both electron conduction and ion diffusion.⁵¹¹¹⁵ There remains a need for improved carbon fiber supported electrode materials that overcome the aforementioned deficiencies.

### SUMMARY

In various aspects, electrode materials and methods of making electrode materials are provided that overcome one or more of the aforementioned problems. In particular, carbon fiber supported electrode materials are provided having fast electron and ion transport. The porous carbon fiber electrodes can include uniform mesoscale pores that are partially filled with a metal oxide layer. With large mass loadings of the metal oxide, the porous carbon fiber electrodes described herein can outperform conventional metal oxide based electrodes at similar loadings. In various aspects, electrode materials are providing having (i) a porous carbon fiber support with a plurality of mesoscale pores having an internal surface and an average pore width of about 2 nm to about 200 nm; and (ii) a metal oxide layer on at least the internal surface of the mesoscale pores. Methods of making the porous carbon fiber electrode materials are also provided. Using a microphase-separation of block copolymers, the methods can provide porous carbon fiber supports that have interconnected and uniform mesoscale pores which can then be deposited with a metal oxide layer.

In particular aspects the metal oxide layer includes manganese oxide, although in various aspects of the disclosure other metal oxides can be used. The metal oxides can include a metal oxide selected from the group consisting of manganese oxide, nickel oxide, cobalt oxide, chromium oxide, iron oxide, copper oxide, zinc oxide, molybdenum oxide, tungsten oxide, aluminum oxide, titanium oxide, and a combination thereof. The metal oxide layer can in some instances be about 0.2 nm to about 5 nm in thickness.

In some aspects, the electrode material is provided where the mesoscale pores have an average pore width of about 10 nm to about 15 nm and a pore volume of about 0.5 cm³ g⁻¹ to about 1.0 cm³ g⁻¹; wherein the metal oxide layer is a manganese oxide layer having an average thickness of about 0.5 nm to about 2.0 nm; wherein the electrode material has a total mass loading of carbon fiber and metal oxide of 5 mg cm⁻² to 15 mg cm⁻²; and wherein the manganese oxide is at least 35% of the total mass loading.

In various aspects, methods of making the electrode materials are also provided. A method is described in some aspects including providing a block copolymer comprising a carbon precursor block and a degradable block, wherein the block copolymer phase separates into first domains rich in the carbon precursor block and second domains rich in the degradable block; heating the block copolymer to a first elevated temperature for a first period of time to induce phase separation and pretreat the carbon precursor block; applying one or both of an acid and a second elevated temperature in an inert or oxidizing atmosphere to convert the carbon precursor block into carbon and to decompose the degradable block to produce a porous carbon fiber; depositing metal oxide layer onto a surface of the porous carbon fiber to form the electrode material.

The electrode materials can be useful in a variety of energy conversion and energy storage devices such as a supercapacitor, battery, or fuel cell. Other systems, methods, features, and advantages of electrode materials and methods of making and uses thereof will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a schematic illustration of an illustrative syntheses of PCF and PCF@MnO₂.

FIGS. 2A-2I are images of the morphology characterizations including SEM images of PCF (FIG. 2A), PCF@MnO₂-1 h (FIG. 2B), PCF@MnO₂-2 h (FIG. 2C), conventional CF (FIG. 2D), CF@MnO₂-1 h (FIG. 2E), and CF@MnO₂-2 h (FIG. 2F). Scale bars: 200 nm. Insets in FIGS. 2A-2F show magnified views of the single fibers. Scale bars: 50 nm. Due to the surface effect, the interconnected mesopores in PCFs appear as discrete dark spots on the fiber skin (inset FIG. 2A) but are absent in the conventional CFs (inset FIG. 2D). FIGS. 2G-2H are TEM images of PCF before (FIG. 2G) and after (FIG. 2H) loading MnO₂ for 2 h. Scale bars: 50 nm.

FIG. 2I is a photograph of a piece of PCF@MnO₂-2 h electrode next to a U.S. penny with a diameter of ˜1.9 cm.

FIGS. 3A-3B are representative cross-sectional SEM images of a fiber of PCFs derived from PAN-b-PMMA (FIG. 3A) and conventional CFs (FIG. 3B). The PCFs show a large number of uniformly distributed, randomly oriented, and interconnected mesopores.

FIGS. 4A-4D demonstrate the morphologies and SAXS spectra of as-spun PAN-b-PMMA, oxidized PAN-b-PMMA and PCF fibers. FIGS. 4A-4C are SEM images of PAN-b-PMMA (FIG. 4A), oxidized PAN-b-PMMA (FIG. 4B) and PCF fibers (FIG. 4C). FIG. 4D is a SAXS spectra of as-spun PAN-b-PMMA, oxidized PAN-b-PMMA, and PCF fibers.

FIGS. 5A-5F demonstrate the results for the electrodeposition of MnO₂ nanoflowers on PCFs. FIG. 5A is an image of the three-electrode setup for the electrodeposition of MnO₂ on PCFs. The inset of FIG. 5A shows a digital photograph of a piece of electrochemically deposited PCF mat. Scale bar, 1 cm. FIG. 5B is a representative SEM image of electrodeposited MnO₂ on PCFs. FIGS. 5C-5D are cyclic voltammograms (CVs) at scan rates of 10-100 mV s⁻¹ (FIG. 5C) and 100-1000 mV s⁻¹ (FIG. 5D). FIG. 5E is a graph of the rate capability of the electrodeposited MnO₂ on PCFs. FIG. 5F is a graph of the Nyquist plot of the electrodeposited MnO₂ on PCFs. The inset of FIG. 5F shows Z′ plotted against the reciprocal of the square root of frequency, w. The best linear fitting line shows a diffusion resistance, σ, of 3.88 Ω s^{-0.5}, much higher than that of MnO₂ on PCFs via redox reaction deposition.

FIGS. 6A-6C are digital photographs (FIG. 6A) and UV-vis spectra (FIGS. 6B-6C) of DI water that have been used to rinse the carbon fiber mats for various number of cycles. After rinsing, the DI water (denoted as supernatant) may contain KMnO4 from the carbon fiber mat.

FIG. 7A is an XPS survey spectrum of PCF@MnO₂-2 h. The peaks associated with Mn are marked. FIG. 7B is an Mn 3 s core-level XPS spectrum. The open circles are the experimental data. The solid and dashed curves represent the best fitting curves. The dotted vertical lines highlight the peak position of the Mn 3 s doublet. The peak separation confirms the valence state of Mn is +4 (MnO₂).

FIGS. 8A-8C demonstrate the Raman and TEM characterizations of MnO₂. FIG. 8A is a Raman spectra of PCF and PCF@MnO₂-2 h. The dashed box highlights the signature Raman peaks of δ-MnO₂. The dashed lines label the D and G peaks of PCF. FIGS. 8B-8C are lattice-resolved TEM images of δ-MnO₂ showing the signature lattice fringes.

FIGS. 9A-9D are nitrogen/77 K (FIG. 9A and FIG. 9C) and carbon dioxide/273 K (FIG. 9B and FIG. 9D) adsorption-desorption isotherms of PCF-based (FIG. 9A and FIG. 9B) and CF-based (FIG. 9C and FIG. 9D) electrodes.

FIGS. 10A-10D demonstrate the physical characterizations of PCF and CF with and without MnO₂. FIGS. 10A-10B are pore size distributions of PCF, PCF@MnO₂-1 h, and PCF@MnO₂-2 h (FIG. 10A) and CF, CF@MnO₂-1 h, and CF@MnO₂-2 h (FIG. 10B). The micropore and mesopore size distributions are measured by the physisorption of carbon dioxide (at 273 K) and nitrogen (at 77 K), respectively, and calculated using the density functional theory. Note the different scales in the micropore and mesopore ranges. Compared to PCFs, CFs contain one order of magnitude lower mesopore volume. The high mesopore volume of PCFs confirms that the mesopores are interconnected and thus are accessible to the adsorbates. FIG. 10C is a plot of the surface areas of PCFs and CFs before and after loading MnO₂. The deposition reaction time increased from 0 to 2 h. FIG. 10D is a plot of the histograms of the mass loadings of (black) carbon fibers and (gray) MnO₂ on supercapacitor electrodes. The solid and dashed bars represent electrodes composed of PCFs and conventional CFs, respectively. The error bars in FIG. 10D are standard deviations determined from at least four independent measurements.

FIGS. 11A-11C demonstrate the ultra-fast electron and ion transport in the PCF-based electrodes. FIG. 11A is a graph of the Nyquist plots collected at open circuit potentials with 5 mV perturbation and a frequency range from 10,000 Hz to 0.1 Hz. The open symbols are experimental data and the solid lines are fitting curves. FIG. 11B is a graph of Z vs. the reciprocal of the square root of frequency (ω^{0.5}) in the intermediate frequency range. The dashed lines are best fitting lines to calculate the diffusion resistance, σ. FIG. 11C is a plot of the ion diffusion resistance of the carbon fiber electrodes in comparison with other reported electrodes: (1) Ref.54; (II) Ref.55; (Ill) Ref.56. The CF-based electrodes show low diffusion resistance and the PCF-based electrodes show ultra-low diffusion resistance.

FIG. 12 is a diagram of the equivalent electric circuit model used for fitting the Nyquist plots. Rₛ: combined series resistance; Ret: charge transfer resistance; CPE_{EDL}: constant phase element representing the electrical double layer capacitance (EDLC); CPE_{P}: constant phase element representing the pseudocapacitance; Z_{w}: Warburg diffusion element.

FIG. 13 is a graph of the Z vs. the reciprocal of the square root of frequency (w-⁰⁵) in the intermediate frequency range. The dashed lines are best fitting lines to calculate the diffusion resistance, σ. The σ of CF, CF@MnO₂-1 h and CF@MnO₂-2 h are 3.33, 5.36, and 6.87 Ω s^{-0.5} respectively.

FIGS. 14A-14D demonstrate the ultra-fast charge-storage kinetics of PCF@MnO₂-2 h. FIG. 14A is a graph of the CVs at various scan rates from 10 to 100 mV s⁻¹. The dashed line highlights the potential (0.2 V) selected for the b-value calculation. FIG. 14B is a graph demonstrating that the absolute current density and scan rate follow the power law, i=kv^{b}, in both the slow and fast scan rate regions. The dashed lines are best fitting lines and the b-value changes only slightly from the slow scan region to the fast scan region. FIG. 14C is a plot of the decoupling of the capacitance contributed by the fast-kinetic processes and the slow-kinetic processes. Even at a high mass loading of MnO₂ (50% of the total mass), the fast-kinetics capacitance still dominates the overall capacitance. FIG. 14D is a plot of the histograms of the capacitance contributions by the different processes: C_{dl}, electrical double layer capacitance.

FIGS. 15A-15E are plots of the decoupling of capacitance contribution from fast-kinetics processes and slow-kinetics processes. CVs are collected at various scan rates from 10 to 80 mV s⁻¹. The fast-kinetics capacitance dominates the overall capacitance.

FIGS. 16A-16D demonstrate the electrochemical performance of PCF, PCF@MnO₂-1 h and PCF@MnO₂-2 h. FIG. 16A is a graph of the CVs at a scan rate of 100 mV s⁻¹. FIG. 16B is a graph of the galvanostatic charge-discharge curves at 10 mA cm⁻² of PCF (squares), PCF@MnO₂-1 h (circles), and PCF@MnO₂-2 h (triangles). FIG. 16C is a radar chart comparing the six figure-of-merits of PCF, PCF@MnO₂-1 h, and PCF@MnO₂-2 h: mass loading of the active materials, rate capability (from 10 to 1000 mV s⁻¹), gravimetric capacitance based on the mass of MnO₂ and the active materials, and areal capacitance based on the geometric area and BET surface area. All capacitances are obtained at 10 mV s⁻¹. FIG. 16D is a plot of the mass loading, gravimetric capacitance, and geometric areal capacitance of PCF-based electrodes in comparison with other reported electrodes. Dashed lines mark the mass loadings in mg cm⁻². Open and filled squares are capacitances based on the mass loadings of MnO₂ and the entire electrodes, respectively. Note that the open (and filled) squares are only to be compared with open (and filled) squares. The labelled points: I, wood-derived porous carbon@MnO₂¹⁴; II, hierarchical MnO₂ on carbon cloth¹²; Ill, carbon nanotube (CNT)@MnO₂₅₈; IV, activated carbon-coated CNT@MnO₂⁵⁹; V, CNT-wrapped polyester fiber@MnO₂¹⁶; VI, carbon nanofoam@MnO₂³³.

FIGS. 17A-17D are graphs of the gravimetric (FIG. 17A and FIG. 17C) and geometric areal capacitances (FIG. 17B and FIG. 17D) of all materials in PCF- (FIGS. 17A-17B) and CF-based (FIGS. 17C-17D) electrodes.

FIGS. 18A-18D are graphs of the gravimetric (FIG. 18A and FIG. 18C) and geometric areal capacitances (FIG. 18B and FIG. 18D) of MnO₂ in PCF- (FIGS. 18A-18B) and CF-based (FIGS. 18C-18D) electrodes.

FIG. 19 is a graph of the charge-discharge cycling stability of PCF@MnO₂-2 h. The inset of FIG. 19 shows the galvanostatic charge-discharge profiles in the 1^{st} and the 5000^{th} cycles. The capacitance retained 98% of its initial value after the 5000 charge-discharge cycles.

FIG. 20 is a Ragone plot of PCF-based electrodes in comparison with CF and graphene-based electrodes in symmetric supercapacitors. References: I—Ref.64; II—Ref.65; III—Ref.66; IV—Ref.67; V—Ref.68. Solid lines are guides for eyes.

### DETAILED DESCRIPTION

This disclosure demonstrates the design of porous carbon fiber (PCF) as a lightweight, flexible, binder-free, and conductive-additive-free support for MnO₂. Using the disparate concept of block copolymer microphase-separation to generate uniform mesopores in PCFs, two mutually exclusive characteristics, i.e., high mass loadings and ultrafast electron and ion transport were simultaneously demonstrated.

An ideal support for MnO₂ and other transition metal oxides (RuO₂, NiO, WO₃, and Fe₂O₃, etc.) needs the characteristics of (1) lightweight, (2) large surface areas for high loadings, (3) high electron conductivity, and (4) low ion diffusion resistivity. However, there is not a single nanostructure that meets all these characteristics^{5,15}. Carbon supports are inherently lightweight and electrically conductive. At high mass loadings of transition metal oxides, the electrical conductivity of electrodes decreases, but it can be restored by blending or wrapping with additional conjugated polymers^{16,17} or carbon additives^{16,18,19}, as shown for excellent supports such as wearable textile structures¹⁶ and graphene^{16,20}. The ion conduction, however, is drastically complicated²¹, and the efficient ion diffusion across the entire support, as well as the thick layer of MnO₂, remains a significant challenge. To mitigate the ion diffusion resistivity, ultrathin layers of MnO₂ have been deposited on model supports, e.g., nanoporous Au^{22,23}, Pt foil⁹, Ni foil²⁴, Si wafer²⁵, dendritic Ni²⁶ and macroporous Ni film²⁷. With a thickness of <10 nm²² or at a mass loading of <0.35 mg cm⁻² on the model supports^{23,26}, MnO₂ exhibits fast electron/ion transport and the gravimetric capacitances approach the theoretical limit. Nevertheless, when the conventional lightweight carbon supports are loaded with MnO₂, they either suffer from a limited surface area for depositing a large amount of MnO₂ thin layers (e.g., carbon cloth^{11,12} carbon fibers^{16,23-30} and other macroporous carbons^{13,14}), or they lack desirable porous structures that facilitate rapid ion diffusion across long distances to maintain high rate capability (e.g., microporous carbons^{5,15,31}).

The design of porous carbon architectures can be important to achieve high mass loading and fast electron/ion transport.^{32,33} This disclosure demonstrates that mesoporous carbon fibers with a narrow pore size distribution are the most preferable for addressing the challenges of high mass loading and fast electron/ion transport. Conversely, micropores are susceptible to clogging after loading with MnO₂ and thus provide sluggish ion transport, while macropores offer limited surface areas for high mass loadings of transition metal oxides. In addition, non-uniform mesopores lead to inefficient use of the surface area for depositing MnO₂ and potential clogging of the small pores.

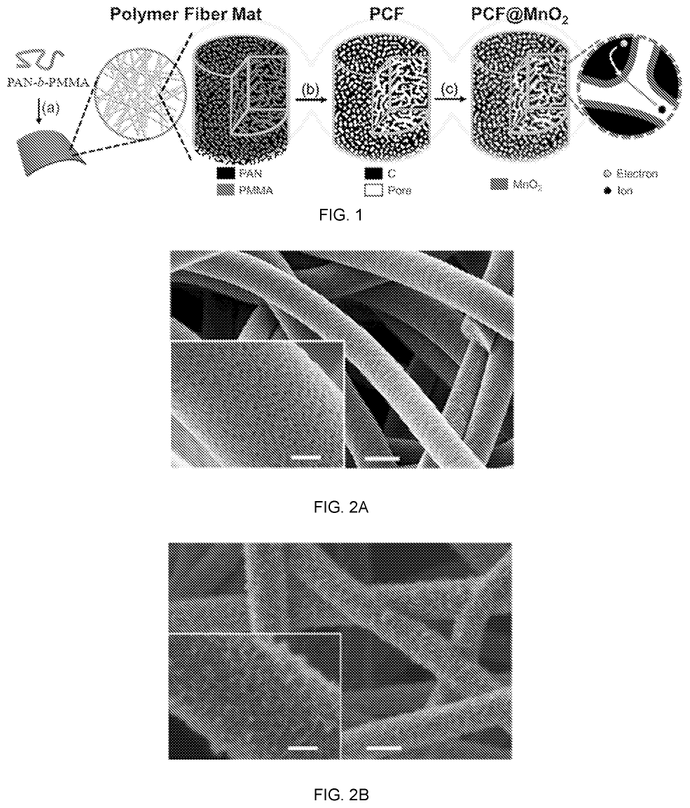

As an exemplary system, block copolymer-derived PCFs are demonstrated as lightweight and high mass-loading supports for MnO₂ (FIG. 1). Because block copolymers self-assemble and microphase separate into uniform and continuous nanoscale domains³⁴⁻⁴¹, after pyrolysis they generate interconnected mesoporous carbons with large surface areas for depositing MnO₂. Disparate from all other carbon supports, the mesopores are designed from the macromolecular level and offer a high degree of uniformity. Importantly, our judiciously designed mesopores have an average diameter of 11.7 nm and are partially filled with a <2-nm-thick layer of MnO₂ (FIG. 1). On the one hand, the remaining mesopores provide continuous channels for efficient ion transport across the entire electrode, significantly reducing the ion diffusion resistance. On the other hand, the fibrous carbon network provides expressways for efficient electron transport without the need for any conductive additives. This contrasts with hard-templated mesoporous carbon particulates (e.g., CMK-3³¹) which demand polymer binders to hold the discrete carbon particulates together. At high mass loadings approaching 7 mg cm⁻², the PCF-supported MnO₂ electrodes (PCF@MnO₂) show superior electron/ion transport and outstanding charge-storage performances.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’.

Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 kN/m³; or a unit disclosed 100° F. is intended to mean an equivalent dimension of 37.8° C.; and the like) as understood by a person of ordinary skill in the art.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Porous Carbon Fiber Electrodes and Methods of Making Thereof

Various electrode materials are provided having a porous carbon fiber support and a metal oxide layer on at least the internal surface of the mesoscale pores. In general the coating thickness of sufficient to provide good electron transport properties while being sufficiently thin so as to not completely block the mesoscale pores, allowing for good ion transport properties.

In some aspects, the electrode material has a Brunauer-Emmett-Teller (BET) surface area from about 60 m² g⁻¹, about 100 m² g⁻¹, or about 150 m² g⁻¹ to about 200 m² g⁻¹, about 250 m² g⁻¹, or about 500 m² g⁻¹ when measured according to the Physisorption Isotherm Method.

The electrode material can have a large mass loading. In some aspects, the electrode material has a total mass loading of carbon fiber and metal oxide from about 2.5 mg cm⁻², about 5 mg cm⁻², or about 7.0 mg cm⁻² and up to about 10 mg cm⁻², 15 mg cm⁻² when measured according to the Mass Loading Method. In some aspects the metal oxide is at least 25%, at least 35%, or at least 40% of the total mass loading when measured according to the Mass Loading Method.

In particular aspects, the electrode material has mesoscale pores having an average pore width of about 10 nm to about 15 nm and a pore volume of about 0.5 cm³ g⁻¹ to about 1.0 cm³ g⁻¹ when measured according to the Physisorption Isotherm Method; the metal oxide layer comprises a manganese oxide layer having an average thickness of about 0.5 nm to about 2.0 nm; the electrode material has a total mass loading of carbon fiber and metal oxide of 5 mg cm-2 to 15 mg cm⁻² when measured according to the Mass Loading Method; and the manganese oxide is at least 35% of the total mass loading.

The electrode materials can generally be formed by providing a porous carbon fiber substrate and depositing a metal oxide layer onto the porous carbon substrate. Although each of the components and methods of making them will be described separately below, it should be understood that the components and the methods can be combined in a variety of ways that will be understood by the skilled artisan upon reading this disclosure. It is the intention that those combinations be covered as of explicitly disclosed herein.

The electrode materials can be used to replace a variety of electrodes used in the art. In some aspects, the electrode material is provided in a device such as a supercapacitor, battery, fuel cell, or other energy conversion or energy storage device. Such devices are generally known in the art and not disclosed in detail herein to sake of brevity.

Porous Carbon Fibers and Methods of Making Thereof

The electrode materials include a porous carbon fiber support having a plurality of mesoscale pores having an internal surface and an average pore width ranging from about 1 nm, about 2 nm, or about 5 nm and up to about 50 nm, about 100 nm, about 200 nm, or about 250 nm. In some aspects, the mesoscale pores have a volume from about 0.05 cm³ g⁻¹, about 0.1 cm³ g⁻¹, or about 0.25 cm³ g⁻¹ and up to about 0.8 cm³ g⁻¹, about 1.0 cm³ g⁻¹, or about 1.5 cm³ g⁻¹ when measured according to the Physisorption Isotherm Method.

The carbon fibers supports are porous and can have a variety of pore sizes from the microscale, to the mesoscale, to the macroscale. The pore sizes and volumes can be measured according to a variety of methods. In some aspects, the pore sizes and volumes are measured using the Physisorption Isotherm Method described herein. The porous carbon fiber support can have a large surface area, e.g. in some aspects the porous carbon fiber support has a Brunauer-Emmett-Teller (BET) surface area from about 60 m² g⁻¹, about 100 m² g⁻¹, or about 200 m² g⁻¹ and up to about 800 m² g⁻¹, about 1000 m² g⁻¹, about 1400 m² g⁻¹, or about 1800 m² g⁻¹. The surface area can be measured according to the Physisorption Isotherm Method.

In some aspects, the porous carbon fiber support includes a plurality of microscale pores wherein the metal oxide layer fills the microscale pores. In some aspects, the porous carbon fiber support has a plurality of microscale pores having an average pore width from about 0.1 nm, 0.2 nm, or 0.5 nm and up to about 1 nm, about 2 nm, or about 5 nm. In some instances, the plurality of microscale pores have a volume from about 0.05 cm³ g⁻¹, about 0.1 cm³ g⁻¹, about 0.12 cm³ g⁻¹, or about 0.15 cm³ g⁻¹ and up to about 0.3 cm³ g⁻¹, about 0.05 cm³ g⁻¹, about 0.08 cm³ g⁻¹, or about 0.1 cm³ g⁻¹ when measured according to the Physisorption Isotherm Method.

In some aspects, the porous carbon fibers support includes macroscale pores. However, in other aspects, the porous carbon fiber support is free or is essentially free of macroscale pores having an average pore width of about 500 nm, about 1 micron, or greater. In some instances, the porous carbon fiber support has a volume of macroscale pores of about 0.01 cm³ g⁻¹ or less.

The porous carbon fiber substrate can be prepared by any suitable method known to those skilled in the art so long as the porous carbon fiber produced has the necessary porosity, i.e. has the correct pore volume, surface area, and pore size distribution for the given application. However, in particular aspects the inventors have found that suitable porous carbon fiber substrates can be prepared via self-assembly of bock copolymers as described herein.

In some aspects, the methods include providing a block copolymer having a carbon precursor block and a degradable block, wherein the block copolymer phase separates into first domains rich in the carbon precursor block and second domains rich in the degradable block; heating the block copolymer to a first elevated temperature for a first period of time to induce phase separation and pretreat the carbon precursor block; and applying one or both of an acid and a second elevated temperature in an inert or oxidizing atmosphere to convert the carbon precursor block into carbon and to decompose the degradable block to produce a porous carbon fiber.

The carbon precursor block can include any block rich in carbons and capable of being decomposed to produce the carbon fibers. In some aspects, the carbon precursor block includes an acrylic block, a cellulosic block, a vinylidene chloride block, a phenolic block, a rayon block, an imide block or a combination thereof. The carbon precursor block can include polyacrylonitrile (PAN) or derivatives thereof with other vinyl ester comonomers such as vinyl acetate, methacrylate, and methyl methacrylate. The carbon precursor block can include a rayon block. The carbon precursor block can include one or more blocks selected from the group consisting of phenolic polymers, polyacenephthalene, polyamide, polyphenylene, poly-p-phenylene benzobisthiazole (PBBT), polybenzoxazole, polybenzimidazole, polyvinyl alcohol, polyvinylidene chloride, polystyrene, and a combination thereof.

The degradable block should generally be able to be degraded to produce the porous carbon fiber substrate and the block sizes should be chosen to produce the desired domain sizes, which should ultimately produce the desired porosities. In some instances, the degradable block is degradable via pyrolysis, photolysis, hydrolysis, or a combination thereof.

The degradable block can include polymethyl methacrylate. In some instances the degradable block is degradable via pyrolysis and the method comprises heating to a second elevated temperature of at least 600° C. in an inert atmosphere.

Metal Oxide Deposition

Uses of Porous Carbon Fiber Electrodes

The electrode materials include a thin layer of metal oxide on at least the internal surfaces of the pores, in particular on the internal surfaces of the mesoscale pores. The metal oxide layer can have an average thickness from about 0.05 nm, about 0.1 nm, about 0.2 nm, or about 0.5 nm and up to about 2.5 nm, about 5 nm, or about 7.5 nm.

Although particular aspects herein demonstrate a manganese oxide layer, in some aspects other metal oxide materials can also be used. In some instances, the metal oxide layer comprises a metal oxide selected from the group consisting of manganese oxide, nickel oxide, cobalt oxide, chromium oxide, iron oxide, copper oxide, zinc oxide, molybdenum oxide, tungsten oxide, aluminum oxide, titanium oxide, and a combination thereof.

Methods of making the electrode materials can include depositing the metal oxide layer onto a suitable porous carbon fiber substrate, and in particular onto those porous carbon fiber substrates made by the methods described herein. The metal oxide can be deposited using a variety of methods such as electrodeposition, preganation, or a combination thereof. In some aspects, the metal oxide is deposited by depositing a metal layer onto the porous carbon fiber and oxidizing the metal layer to produce the metal oxide layer.

Measurement Methods

Mass Loading Method

The mass loading (mₛ, in mg cm²) of metal oxide on the carbon fibers can be determined using the mass difference (in mg) before and after the deposition of the metal oxide (m_{after}−m_{before}). For self-limiting redox deposition, the mass loadings can be calculated according to the appropriate stoichiometric relationship for the metal oxide. For electrochemical deposition, the mass loadings (in mg cm⁻²) of metal oxide can be calculated based on the mass difference before and after the electrodeposition: mₛ=m_{after}−m_{before}/S_{geo} where S_{geo} is the geometric area (in cm²) of the carbon mat used for deposition

Physisorption Isotherm Method

The physisorption isotherms can be measured with a pore analyzer such as 3Flex Pore Analyzer, Micromeritics Instrument Corp. using nitrogen (for mesopores) and carbon dioxide (for micropores). Prior to the sorption tests, all electrodes can be heated at 90° C. for 60 min and then at 200° C. for 900 min in N₂ to desorb any moisture and hydrocarbons. The ramping rate of both heating processes is 10° C. min⁻¹. The surface area can be calculated using the Brunauer-Emmett-Teller (BET) method, and the pore size distributions can be obtained by the density functional theory

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

Methods

Synthesis of Porous Carbon Fiber Mats

Porous carbon fiber (PCF) mats were derived from poly(acrylonitrile-block-methylmethacrylate) (PAN-b-PMMA) block copolymer. Briefly, PAN-b-PMMA (Mn=110-b-60 kDa, polydispersity=1.14) was synthesized via reversible addition-fragmentation chain-transfer polymerization⁶¹ and electrospun into a polymer fiber mat. The polymer fiber mat was cut into small stripes (e.g., 10 cm×2 cm), loaded into a tube furnace (Thermo-Fisher Scientific, Model STF55433C-1), and then heated at 280° C. for 8 h (ramp rate: 1° C. min⁻¹) in air. The heating process induced the microphase separation of PAN and PMMA, and it triggered the crosslinking and cyclization of PAN. The resulting brown mats were further heated at 1200° C. for 1 h (ramp rate: 10° C. min⁻¹) under a nitrogen atmosphere. Afterwards, the tube furnace was cooled down to room temperature and PCF mats were obtained. The preparation of CF was similar except that PAN was used instead of PAN-b-PMMA.

Deposition of Manganese Dioxide.

Manganese dioxide (MnO₂) was deposited onto the PCF mats via a solution-based self-limiting redox reaction with potassium permanganate (KMnO₄),

4KMnO₄+3C+H₂O→4MnO₂+K₂CO₃+2KHCO₃

First, 0.032 g of KMnO₄ powder was dissolved in 20 mL of deionized water and used as the deposition solution (KMnO₄, 10 mM). The solution was then heated to 80° C. under ambient pressure. Approximately 10 mg of PCF mats were soaked in the solution for 1-2 h under gentle stirring. After the reaction, the KMnO₄ solution was drained and the remaining carbon fiber mats were thoroughly washed with deionized water five times, followed by drying in a vacuum oven at 60° C. for 8 h. The resulting carbon fiber mats are designated as PCF@MnO₂-1 h and PCF@MnO₂-2 h based on the reaction times of 1 h and 2 h, respectively.

The mass loading of MnO₂ was determined by calculating the mass difference between the PCF mats before and after the reaction. The areal mass loadings of MnO₂ in PCF@MnO₂-1 h and PCF@MnO₂-2 h were 2.6±0.2 and 3.4±0.4 mg cm⁻², respectively. The total mass loadings (including PCF and MnO₂) of PCF@MnO₂-1 h and PCF@MnO₂-2 h were 6.2±0.3 and 6.8±0.4 mg cm⁻², respectively. The average thickness of all PCF, PCF@MnO₂-1 h and PCF@MnO₂-2 h mats was ˜200 μm. Thus, the volumetric mass densities of PCF@MnO₂-1 h and PCF@MnO₂-2 h were 0.31±0.02 and 0.34±0.02 g cm⁻³, respectively. The standard deviations were based on at least three batches of carbon fiber based electrodes.

Electrochemical deposition was also adopted to prepare PCF@MnO₂ electrodes with high mass loadings. The electrodeposition solution contained 0.1 M manganese acetate and 0.5 M lithium chloride (a supporting electrolyte) in deionized water. A piece of PCF carbon fiber mat, a piece of nickel foam, and an Ag/AgCl wire in saturated KCl aqueous solution were used as the working electrode, the counter electrode, and the reference electrode, respectively. The electrodes were connected to an electrochemical workstation (PARSTATS 4000+, Princeton Applied Research, Ametek Inc.) and scanned between 0 and 1.0 V vs. Ag/AgCl at a scan rate of 0.01 mV s⁻¹ for 15 cycles. The mass loading of the electrodeposited MnO₂ on the PCF was 4.2 mg cm⁻². The total mass loading (including PCF and MnO₂) from electrodeposition was ˜8.0 mg cm⁻².

Physical Characterizations

The carbon fibers were characterized using scanning electron microscopy (SEM, LEO Zeiss 1550, acceleration voltage: 2 kV) and high-resolution transmission electron microscopy (HRTEM, FEI TITAN 300, acceleration voltage: 300 kV). The physisorption isotherms were measured with a pore analyzer (3Flex Pore Analyzer, Micromeritics Instrument Corp.) using nitrogen (for mesopores) and carbon dioxide (for micropores). Prior to the sorption tests, all electrodes were heated at 90° C. for 60 min and then at 200° C. for 900 min in N₂ to desorb any moisture and hydrocarbons. The ramping rate of both heating processes was 10° C. min⁻¹. The surface area was calculated using the Brunauer-Emmett-Teller (BET) method, and the pore size distributions were obtained by the density functional theory. X-ray photoelectron spectroscopy (XPS) spectra were acquired using monochromatic Al K_{α} X-ray source (1486.6 eV) with a 200 μm X-ray beam at an incident angle of 45°. All binding energies are referenced to adventitious C 1 s at 284.8 eV. Chemical states of elements were assigned based on the National Institute of Standards and Technology (NIST) XPS Database. Raman spectra were recorded by a Raman spectrometer (WITec alpha 500) coupled with a confocal Raman microscope using a laser excitation wavelength of 633 nm. UV-vis spectra were measured by an Agilent Cary 60 UV-vis spectrometer. Small angle X-ray scattering (SAXS) spectra were collected by a Bruker N8 Horizon instrument with Cu Kα radiation (A=1.54 Å) at a current of 1 mA and a generator voltage of 50 kV.

Electrochemical Characterizations

The electrochemical performance was evaluated in a symmetric two-electrode configuration in an aqueous electrolyte of 6 M KOH. For consistency, carbon fiber mats were sandwiched between two pieces of nickel foams (EQ-bcnf-80 μm, MTI corporation). Cyclic voltammograms were collected within a potential window of 0-0.8 V at various scan rates of 10-1000 mV s⁻¹. Galvanostatic charge and discharge (GCD) were performed within the same potential window (0-0.8 V). Electrochemical impedance spectroscopy was conducted at open circuit potentials with frequencies between 0.1 Hz and 100 kHz with a perturbation of 5 mV. The CVs and EIS were recorded using a PARSTATS 4000+ electrochemical workstation (Princeton Applied Research, Ametek Inc.). The GCD curves were acquired from a charge-discharge cycler (Model 580, Scribner Associates Inc.).

Mass Loadings

The mass loading (mₛ, in mg cm⁻²) of MnO₂ on the carbon fibers was determined using the mass difference (in mg) before and after the deposition of MnO₂ (m_{after}−m_{before}). For self-limiting redox deposition, the mass loadings were calculated according to the stoichiometric relationship of 3C˜4MnO₂˜(m_{after}−m_{before}) using the equation below.

$${m}_{s} = \frac{( {m}_{after} - {m}_{before} ) \times ( 4 {M}_{MnO 2} )}{Δ M \times {S}_{g e o}} \qquad ( 1 )$$

where M_{MnO2} is the molar mass of MnO₂ (=86.9 g mol⁻¹), S_{geo} is the geometric area (in cm²) of the carbon mat used for deposition, and ΔM=4M_{MnO2}−3M_{C} is the molecular mass difference (in g mol⁻¹) between 4 mol of MnO₂ and 3 mol of carbon, according to the following reaction:

$$4 {KMnO}_{4} + 3 C + {H}_{2} O \to 4 {MnO}_{2} + {K}_{2} {CO}_{3} + 2 {KHCO}_{3}$$

For electrochemical deposition, the mass loadings (in mg cm⁻²) of MnO₂ were calculated based on the mass difference before and after the electrodeposition:

$${m}_{s} = \frac{{m}_{after} - {m}_{before}}{{S}_{g e o}} \qquad ( 2 )$$

Capacitances

The gravimetric capacitance (Cₘ, in F g⁻¹) of a single electrode (in a symmetric two-electrode testing configuration) is calculated using CV curves:

$${C}_{m} = \frac{2 {C}_{device}}{{m}_{device} / 2} = \frac{4}{2 ( {U}_{H} - {U}_{L} ) v} {\int }_{{U}_{L}}^{{U}_{H}} {I}_{m} d V \qquad ( 3 )$$

where C_{device} is the measured capacitance of the device (in F), m_{device} is the total mass of the two electrodes (in g), Iₘ is the current density (in A g⁻¹), ν is the scan rate (in V s⁻¹), and V_{H} and V_{L} are the upper and lower limit of the potential window (both in V), respectively. The current was normalized to the total mass of the active materials in both positive and negative electrodes.

The geometric-areal normalized capacitance (C_{s,geo}, in mF cm⁻²), BET-areal normalized capacitance (C_{s,BET}, in pF cm⁻²) and volumetric capacitance (Cᵥ, in F cm⁻³) of a single electrode are derived from Cₘ as follows:

$$\begin{matrix}{C}_{s , g e o} = {C}_{m} \times {m}_{s} & ( 4 ) \\ {C}_{s , B E T} = \frac{{C}_{m}}{{s}_{B E T}} ( in F {m}^{- 2} ) = \frac{{C}_{m}}{{s}_{B E T}} \times 100 ( in µF {cm}^{- 2} ) & ( 5 ) \\ {C}_{V} = {C}_{m} \times {m}_{V} & ( 6 )\end{matrix}$$

where mₛ, S_{BET}, and my represent areal mass loading (in mg cm⁻²), BET specific surface area (in m² g⁻¹) and electrode packing density (in g cm⁻³), respectively.

Energy Density and Power Density

Gravimetric power density (Pₘ, W kg⁻¹) and gravimetric energy density (Eₘ, Wh kg⁻¹) are evaluated in a two-electrode symmetric configuration and based on the total mass of the two electrodes.

$$\begin{matrix}{E}_{m} = \frac{( {C}_{m} / 4 ) \times {( {U}_{H} - {U}_{L} )}^{2}}{2} ( in W s {g}^{- 1} ) = \frac{( {C}_{m} / 4 ) \times {( {U}_{H} - {U}_{L} )}^{2}}{2} \times \frac{1000}{3600} ( in Wh {kg}^{- 1} ) & ( 7 ) \\ {P}_{m} = \frac{3600 {E}_{m}}{{t}_{discharge}} = \frac{3600 {E}_{{m}^{v}}}{{U}_{H} - {U}_{L}} & ( 8 )\end{matrix}$$

Where Cₘ/4 represents the device capacitance of a two-electrode symmetric pseudocapacitor device (in F g⁻¹), t_{discharge} is the discharge time (in s) and the coefficient 3600 is the conversion factor from hour to second (1 h=3600 s). Other parameters follow the same definition as defined.

Capacitance Differentiation (The Dunn's Method)

The Dunn's method was used to quantify the capacitance contribution from fast-kinetic processes (including electrical double layer capacitive processes and fast redox reactions) and slow-kinetic processes (redox reactions that are diffusion-controlled).

First, the current density at a fixed potential and a scan rate, i, was extracted from the CV curves. According to Wang et al.,⁶² the current density, i, is a function of the scan rate, ν, and can be expressed as the sum of two terms v:

$$i ( v ) = {k}_{1} v + {k}_{2} {v}^{0.5} \qquad ( 9 )$$

where k₁ and k₂ are constants. The first term k₁ν equals the current density contributed from fast-kinetic processes and the second term k₂ν^{0.5} is the current density associated with slow-kinetic (or diffusion-controlled) processes. By dividing ν^{0.5} on both sides of the equation, it yields:

$$i {v}^{- 0.5} = {k}_{1} {v}^{0.5} + {k}_{2} \qquad ( 10 )$$

Therefore, i ν^{-0.5} and ν^{0.5} are expected to have a linear relationship. The slope equals k₁ and the y-intercept equals k₂. By repeating the above steps for other potentials and scan rates, the capacitance contribution from the fast-kinetic and slow-kinetic processes can be mapped out.

b-Value Analysis

The b-value analysis was performed to evaluate the charge-storage kinetics of the electrodes by cyclic voltammetry. According to Augustyn et al.,⁶³ the current densities at different scan rates and a fixed potential obey the following power-law relationship:

i(ν)=kν^{b} (11)

where k is a pre-exponential constant and b is a real number between 0.5 and 1.0. When b equals 0.5, the charge-storage processes are sluggish due to the slow ion diffusion in the electrode. For instance, most battery electrodes store charges via slow solid-state ion diffusion and thus their b values typically approximate to 0.5. When b equals 1.0, the charge-storage processes are rapid and are not diffusion limited. For supercapacitor electrodes that store charges via surface reaction/sorption, solid-state diffusion is not involved and thus the b values are expected to be close to 1.0. For pseudocapacitive electrodes that involve ion diffusion across a thick layer of transition metal oxides, the b values deviate from 1.0. Typically, large deviations of the b values from one signify slow electron conduction and/or ion diffusion.

To obtain the b value, one can take logarithm on both sides of Equation 11 and convert it to the following:

log₁₀i=b log₁₀ν+C (12)

where C is a constant that equals log₁₀k. Based on Equation 12, a linear relationship shall be observed between i and v in a logarithmic scale. The b value is the slope of the best linear fitting line.

SAX Characterizations

The center-to-center pore-spacing, d (in nm), was estimated based on the SAXS spectra:

$$d = \frac{2 }{\vert q \vert} \qquad ( 13 )$$

where |q| is the magnitude of characteristic scattering vector (in nm⁻¹).

Results

Morphology

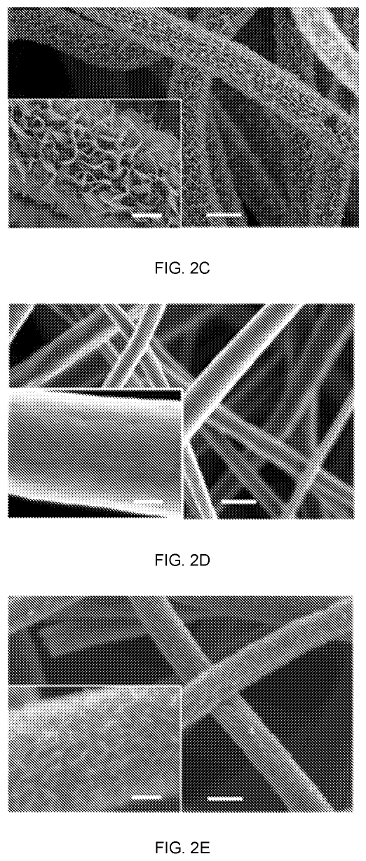

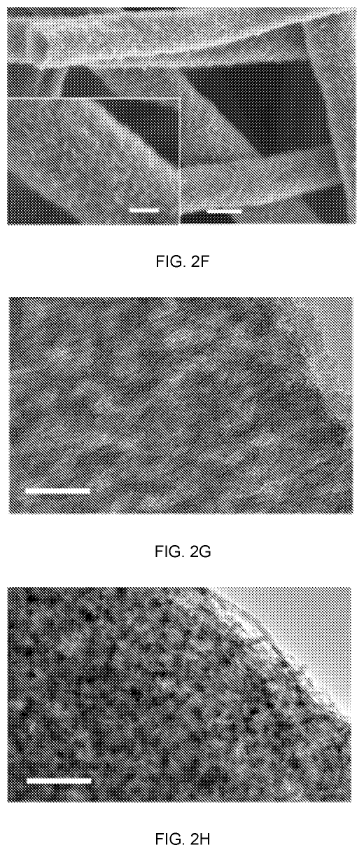

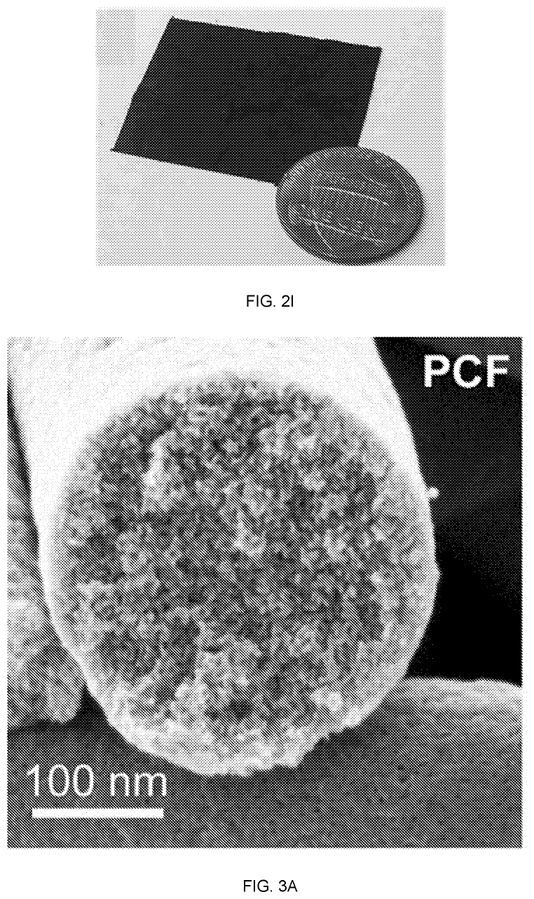

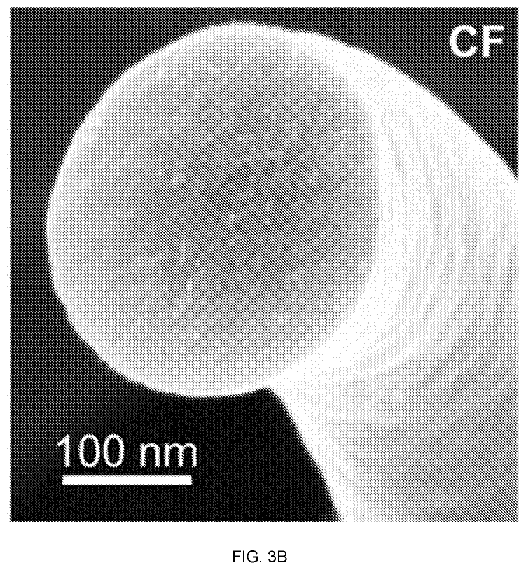

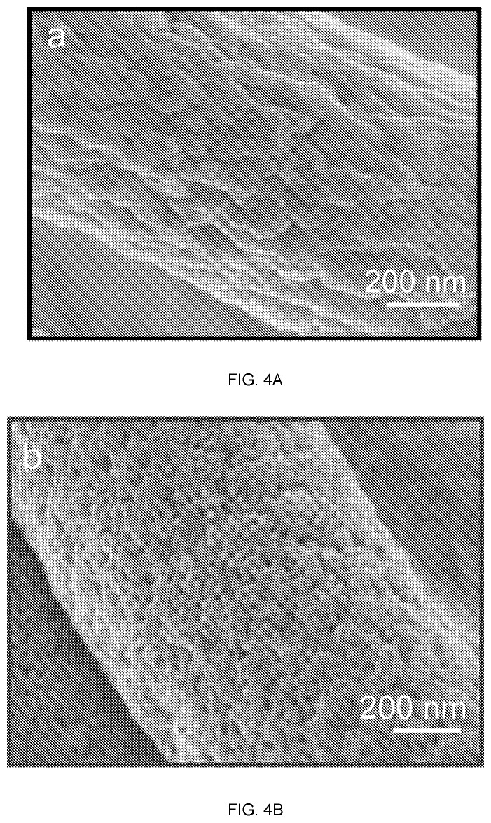

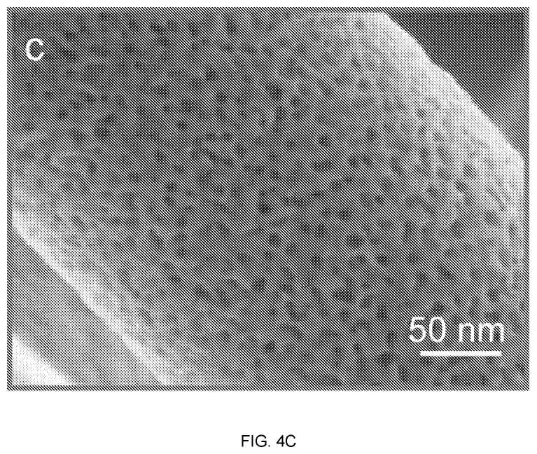

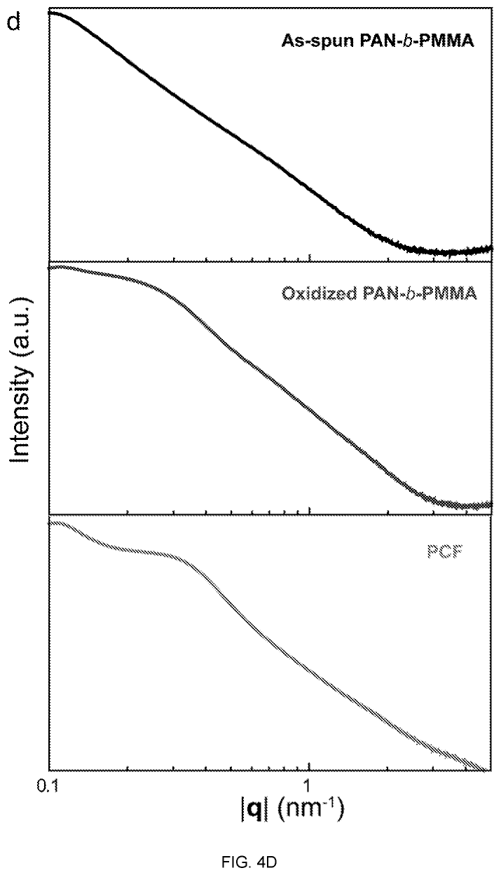

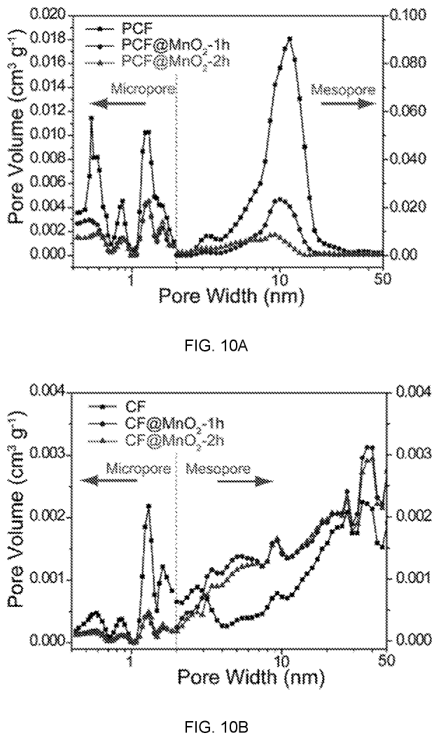

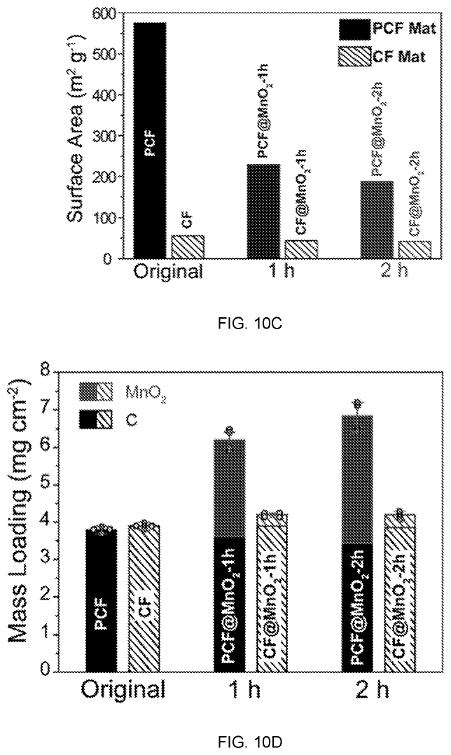

To illustrate the importance of uniform mesopores for high mass loading of MnO₂, two types of carbon fibers were synthesized, i.e., PCFs with uniform mesopores derived from poly(acrylonitrile-block-methyl methacrylate) (PAN-b-PMMA) and conventional carbon fibers (CFs) with limited mesopores from pure polyacrylonitrile (PAN). Scanning electron microscopy (SEM) shows the contrasting morphologies of PCFs and CFs (FIG. 2A, FIG. 2D, and FIGS. 3A-3B). Owing to the microphase separation of PAN-b-PMMA and the subsequent degradation of poly(methyl methacrylate) (PMMA), the PCFs were perforated with a large amount of uniformly distributed, randomly oriented, and interconnected mesopores of ˜11.7 nm (FIG. 2A, FIG. 10A, and FIG. 3A)⁴². In contrast, the CFs derived from PAN exhibited relatively smooth surfaces and no observable mesopores under SEM (FIG. 2D and FIG. 3B). Small angle X-ray scattering (SAXS) spectroscopy confirmed the microphase separation of PAN-b-PMMA and revealed that the average center-to-center pore-spacing in PCFs was 25.7 nm (FIGS. 4A-4D). The volume fraction of PAN in PAN-b-PMMA was ˜65%, and supposedly the block copolymer should self-assemble into either cylindrical or gyroidal structures, depending on the incompatibility of the two blocks. After pyrolysis, however, the porous carbon fibers showed no well-defined cylindrical or gyroidal structures but interconnected mesopores that were irregularly shaped and uniformly distributed, as shown in the cross-sectional SEM image (FIG. 3A). This morphology is attributed to the crosslinking of PAN at elevated temperatures, which hindered the microphase separation of PAN-b-PMMA into well-defined cylindrical or gyroidal structures, similar to the crosslinking-induced hindering effect in previous reports^{43,44}.

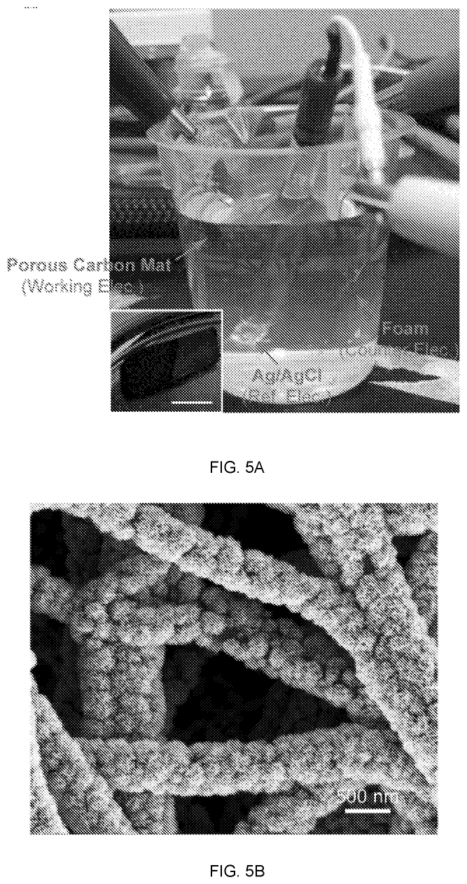

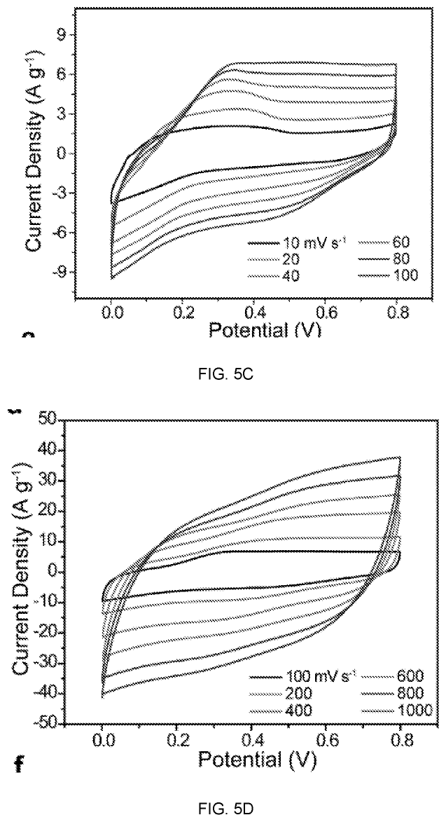

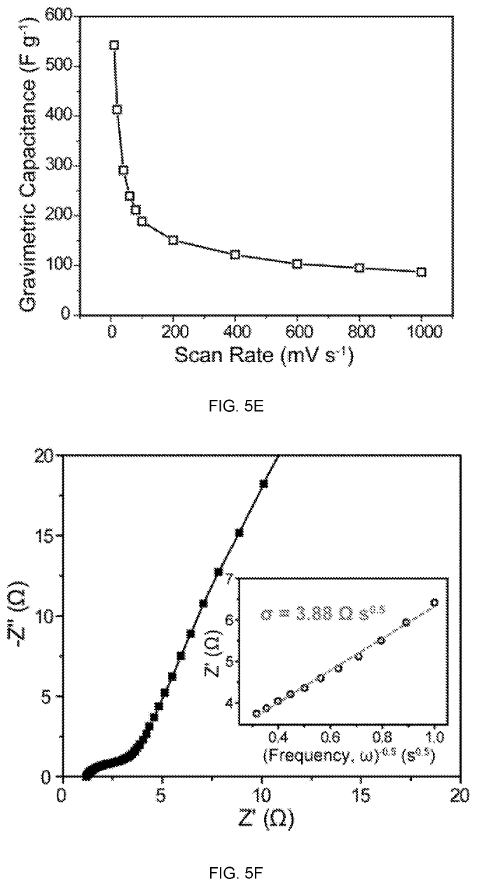

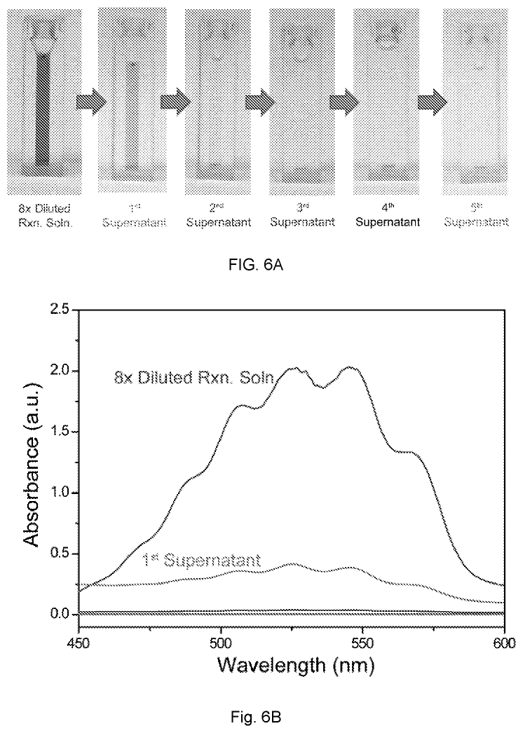

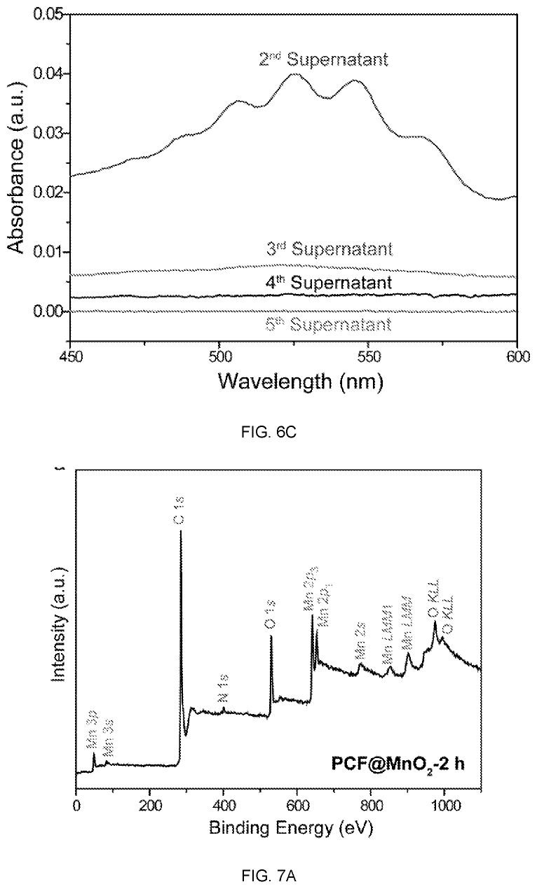

The two types of carbon fibers were immersed in aqueous solutions of potassium permanganate (KMnO₄, 10 mM) at 80° C. to deposit MnO₂ on their surfaces. The solution-based redox deposition was chosen because it creates a conformal and homogenous layer of MnO₂ inside the pores via a self-limiting redox reaction between KMnO₄ and carbon^{32,45,46} Compared with electrochemical deposition (FIGS. 5A-5F), the redox reaction deposition is advantageous because it yields uniform and homogenous layers of MnO₂ on PCFs that ensure a low ion diffusion resistance and thus, a high rate capability. After the deposition, the carbon fibers were washed thoroughly with deionized water, and the supernatant were analyzed with UV-vis spectroscopy to assure that there was no residual KMnO₄ in the carbon fibers (FIGS. 6A-6C). As shown by SEM, MnO₂ started to grow confocally on PCF within the first hour (FIG. 2B), and it continued to grow into nanosheets when the deposition time was prolonged to 2 h (FIG. 2C). The growth of MnO₂ on conventional CFs, however, differed drastically. After depositing for 2 h, the surface of CF@MnO₂-2 h (FIG. 2F) did not change significantly from CF@MnO₂-1 h (FIG. 2E). Only a thin layer of MnO₂ nanosheets was present on the surfaces of both CF@MnO₂-1 h and CF@MnO₂-2 h, confirming that the block copolymer-derived PCFs afford a much higher loading of MnO₂ than pure PAN-derived CFs. To verify the successful deposition of MnO₂ in the mesopores, the transmission electron microscopy (TEM) images of PCF (FIG. 2G) and PCF@MnO₂-1 h (FIG. 2H) were compared. Black spots of MnO₂ were uniformly embedded in PCF@MnO₂-1 h, while they were absent in PCF before loading with MnO₂. MnO₂ appeared black because Mn has a higher atomic number than carbon does. The PCF mats were prepared on a large scale and ready for use as electrodes without binders or conductive additives (FIG. 2I).

Chemical and Physical Properties

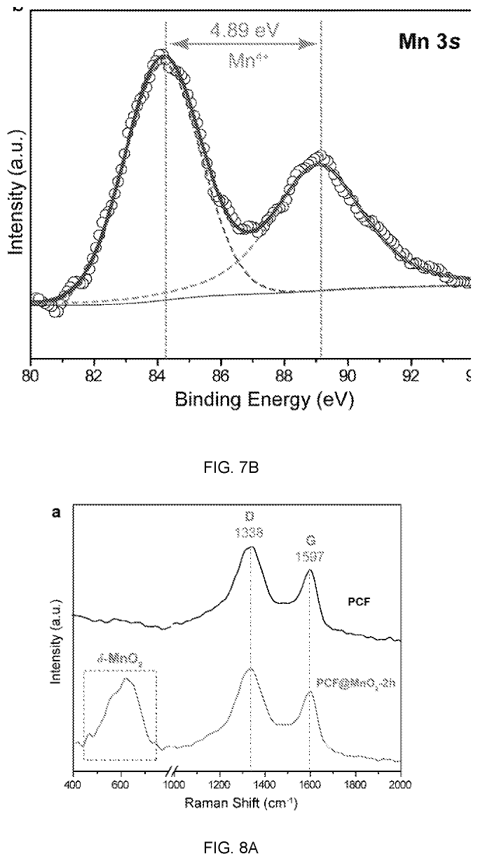

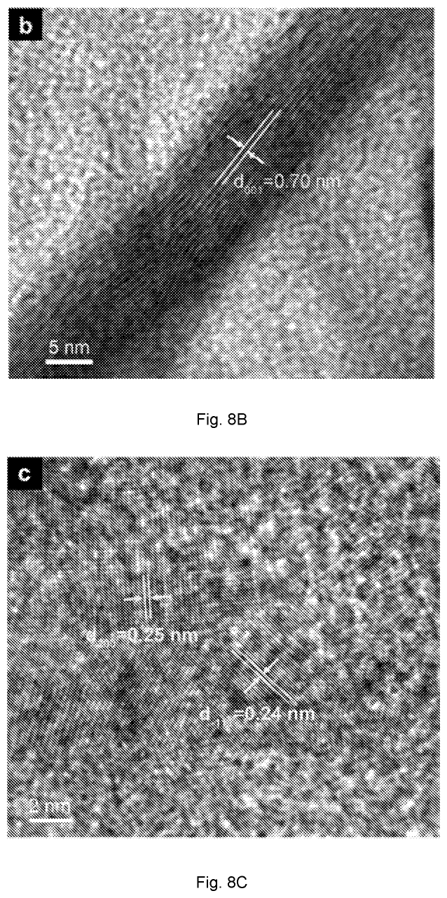

X-ray photoelectron spectroscopy (XPS), Raman spectroscopy, and high-resolution TEM orthogonally verified the successful loading of MnO₂ onto PCF. The XPS spectrum (FIG. 7A) of PCF@MnO₂-2 h showed peaks of C, O, and N corresponding to the carbon fibers, as well as a full set of peaks corresponding to Mn. An examination of the Mn 3 s core-level XPS spectrum (FIG. 7B) revealed that the separation between the doublet was 4.89 eV, corroborating the valence state of Mn(IV)⁴⁷. After MnO₂ deposition, the Raman spectrum of PCF@MnO₂-2 h (FIG. 8A) showed a group of peaks centered at ˜600 cm⁻¹ corresponding to birnessite-phase manganese dioxide (δ-MnO₂)⁴⁸. The birnessite-phase of MnO₂ was also proven by the characteristic lattice fringes in the lattice-resolved TEM images (FIGS. 8B-8C). Among the various types of MnO₂, δ-MnO₂ is one of the most suitable phases for fast charge-discharge because its layered structure allows for rapid ion diffusion⁴⁹.

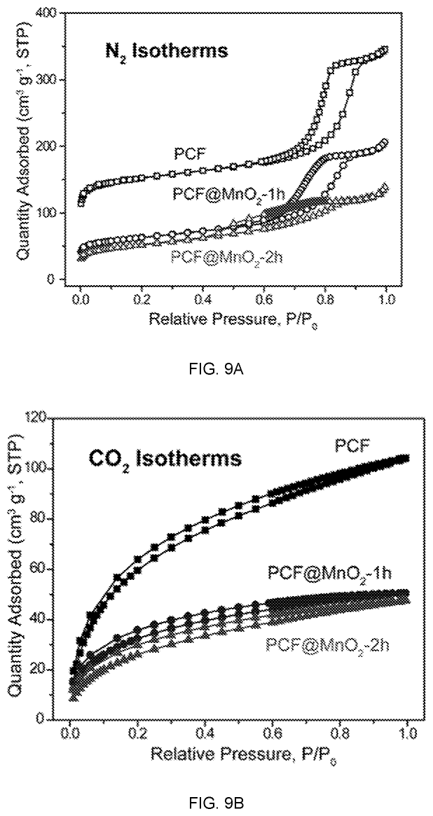

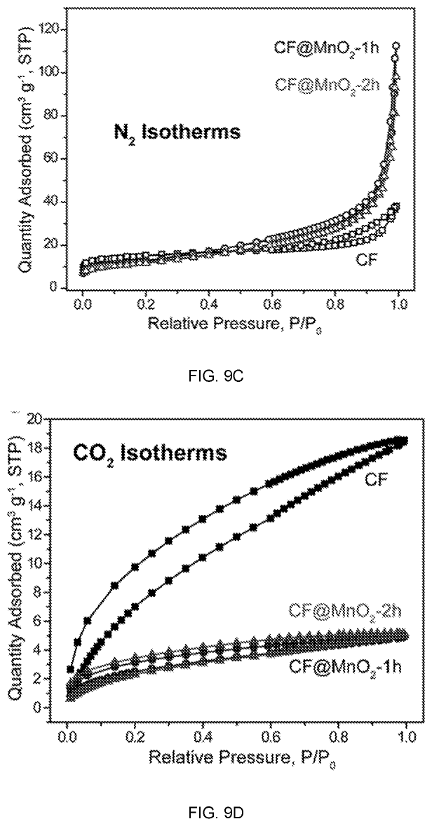

The porous structures of carbon fibers changed after loading with MnO₂. The pore size distributions of mesopores and micropores were evaluated by nitrogen and carbon dioxide adsorption-desorption isotherms, respectively (FIGS. 9A-9D). PCFs possessed significantly larger numbers of both mesopores and micropores. After depositing MnO₂, the micropore volumes of PCFs and CFs steadily decreased at all pore widths, but the peak positions remained unchanged (FIGS. 10A-10B), suggesting that the micropores were either completely filled or clogged by MnO₂. The pore size distributions of PCFs and CFs, however, were different in the mesopore range. PCFs exhibited appreciable decrease in the mesopore volume after depositing MnO₂. In addition, the peak position shifted from 11.7 to 10.0 nm after 1 h, and further down to 9.3 nm after 2 h, suggesting that the average thickness of the MnO₂ layer inside the pores was ˜0.9 nm and ˜1.2 nm after depositing for 1 h and 2 h, respectively. These thicknesses are desirable for high capacitive performance, as suggested by the Au model in a previous report²². The reduction of mesopore size suggests that the mesopores were only partially filled with MnO₂, and therefore they remained accessible to the gas adsorbates and ions. As shown in Table 1, the pore volume reduced more in the mesopore range (86.1% reduction after the 2-h deposition) than in the micropore range (66.0% reduction after 2-h deposition). On the contrary, the mesopore volume of CFs, which was two orders of magnitudes lower than that of PCFs, increased after depositing MnO₂ (FIG. 10B). The increase in the mesopore volume of CFs is ascribed to the porous structures formed by MnO₂ as shown in FIGS. 2E-2F. The total pore volumes of CF-based electrodes were at least one order of magnitude lower than those of PCF-based electrodes.

TABLE 1
Surface area and porosity of CF- and PCF-based electrodes.

| | BET Surface | Micropore | Mesopore | Macropore |
|---|---|---|---|---|
| | Area | Volume | Volume | Volume |
| Sample | (m² g⁻¹) | (cm³ g⁻¹) | (cm³ g⁻¹) | (cm³ g⁻¹) |
| PCF | 574.8 ± 1.9 | 0.1440 | 0.8690 | 0.0067 |
| PCF@MnO₂-1 h | 229.6 ± 0.4 | 0.0582 | 0.2100 | 0.0063 |
| PCF@MnO₂-2 h | 187.5 ± 1.1 | 0.0494 | 0.1200 | 0.0062 |
| CF | 55.3 ± 0.1 | 0.0177 | 0.0210 | 0.0064 |
| CF@MnO₂-1 h | 43.4 ± 0.3 | 0.0048 | 0.1293 | 0.0644 |
| CF@MnO₂-2 h | 41.8 ± 0.2 | 0.0048 | 0.1172 | 0.0557 |

The incorporation of MnO₂ into PCFs and CFs also altered the surface area (FIG. 10C). The surface area of the PCF mat (574.8 m² g⁻¹) was more than ten times higher than that of the CF mat (55.31 m² g⁻¹). Upon loading with MnO₂, the surface area of PCFs decreased from 574.8 to 229.5 m² g⁻¹ for PCF@MnO₂-1 h, and further down to 187.5 m² g⁻¹ for PCF@MnO₂-2 h. In contrast, the surface area of CFs only experienced moderate decreases from 55.31 to 43.35 m² g⁻¹ for CF@MnO₂-1 h and to 41.76 m² g⁻¹ for CF@MnO₂-2 h.

The higher loadings of MnO₂ in PCFs than in CFs is due to the large amount of uniform mesopores (FIG. 10D). The total mass loadings (including carbon fibers and MnO₂) of PCF, PCF@MnO₂-1 h, and PCF@MnO₂-2 h were 3.8±0.1, 6.2±0.3, and 6.8±0.4 mg cm⁻², respectively. The error bars (±values) are standard deviations determined from at least four independent measurements. MnO₂ accounted for 42% and 50% of the total mass of PCF@MnO₂-1 h and PCF@MnO₂-2 h, respectively. In contrast, CF-based electrodes showed much smaller mass loadings of 3.9±0.1, 4.2±0.1, and 4.3±0.2 mg cm⁻² for CF, CF@MnO₂-1 h and CF@MnO₂-2 h, respectively. MnO₂ only contributed ˜9% of the total mass of CF@MnO₂-1 h and CF@MnO₂-2 h. The difference in the mass loading of MnO₂ on PCFs and CFs is also apparent in the SEM images (FIGS. 2A-2I). The comparison shows that the uniform mesopores are indispensable in realizing the high mass loading of MnO₂ on the carbon fibers. The abundant mesopores provide large solution-accessible surface areas for loading MnO₂ on the PCFs, while micropores can only host a limited amount of MnO₂ because the deposition solution can barely access them. The mass of all carbon fibers reduced slightly after loading with MnO₂, due to the consumption of carbon by the redox reaction between carbon and KMnO₄. Further elongating the deposition time to 3 h showed no appreciable increase in MnO₂ loading, confirming that the redox deposition was self-limited.

Ultra-Fast Electron and Ion Transport

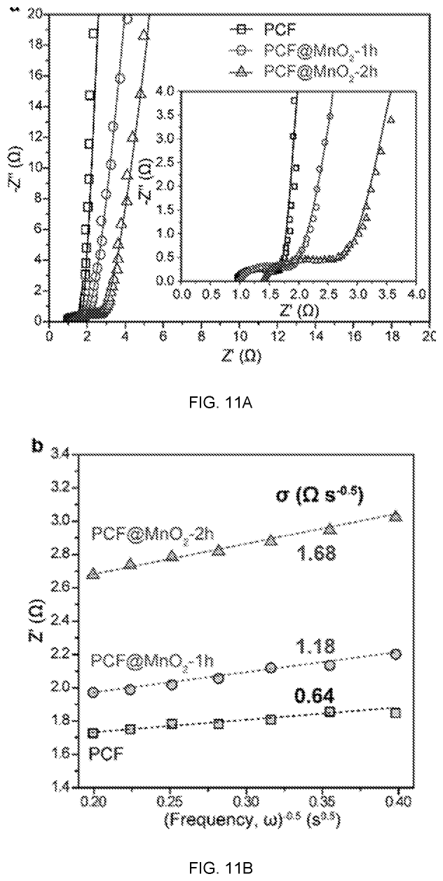

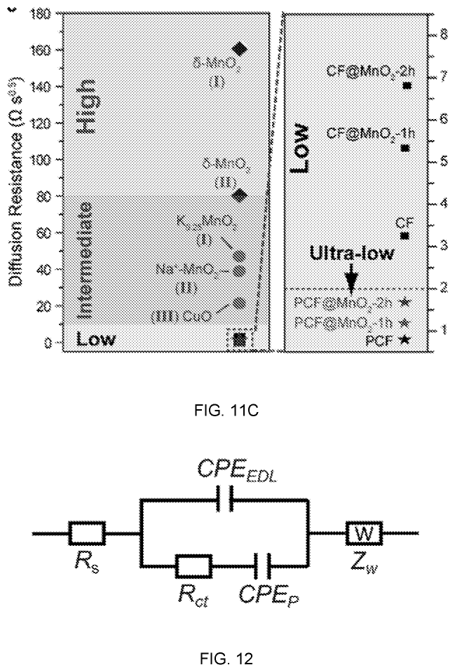

Considering the high loading of MnO₂ and the large amount of mesopores for ion transport, the performance of the PCF-based electrodes for pseudocapacitors was investigated. The electron transport and ion diffusion resistivity were analyzed with electrochemical impedance spectroscopy (EIS). The Nyquist plots of PCF, PCF@MnO₂-1 h and PCF@MnO₂-2 h (FIGS. 11A-11C) exhibited incomplete semicircles followed by linear tails, which resemble the features of mixed kinetic-diffusion controlled processes and are typical for pseudocapacitive materials⁵⁰. To obtain the resistances, the EIS spectra were fit with an equivalent electric circuit (FIG. 12). The combined series resistances (Rₛ) of PCF and PCF@MnO₂-1 h were 1.0Ω, and that of PCF@MnO₂-2 h increased to 1.4Ω (inset of FIG. 11A). The Rₛ values were comparable to highly conductive carbon-based materials in aqueous electrolytes⁵¹⁻⁵³, indicating that MnO₂ introduced minimal changes to the electrical resistance of the electrodes despite the high loadings. In addition, the charge-transfer resistances (R_{ct}, the semicircles in inset of FIG. 11A) of PCF, PCF@MnO₂-1 h and PCF@MnO₂-2 h are 0.74, 0.86 and 1.30Ω, respectively. The small resistances suggest efficient electron transfer associated with the redox reaction of MnO₂. The augmentation of charge-transfer resistance in PCF@MnO₂-2 h is mainly due to the increased thickness of MnO₂ deposited in the mesopores (evidenced by the reduction in mesopore-width shown in FIG. 10D). The increased thickness elongates the electron transport distance in MnO₂ and therefore obstructs electron transfer at the MnO₂/electrolyte interface, because MnO₂ is a poor electron conductor (10⁻⁵˜10⁻⁶ S cm⁻¹). The small Rₛ and Rd are key attributes of the block copolymer-based carbon fiber electrodes because 1) unlike discrete carbon particles or graphene flakes, the carbon fibers offer continuous expressways for electron conduction, and 2) the block copolymers endow the carbon fibers with high surface areas to load with an ultrathin layer of δ-MnO₂, which mitigates the insulating problem and facilitates the electron transport.

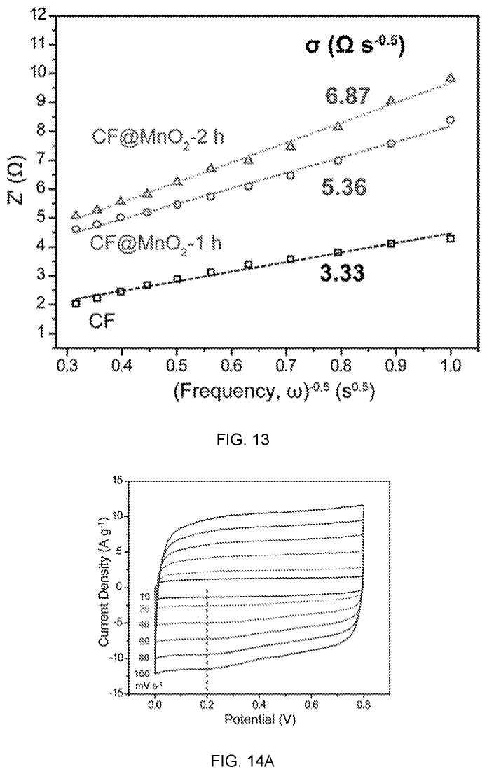

In addition to the efficient electron transport, the block copolymer-derived PCF electrodes exhibited ultra-fast ion diffusion kinetics, as featured by their ultra-small diffusion resistances (a). The values of a were extracted from the slopes of the linear fitting lines of the real part of impedance (Z) versus the reciprocal of the square root of frequency (ω^{0.5}) (FIG. 11B). PCFs displayed the smallest a of 0.64 Ω s^{-0.5}, followed by PCF@MnO₂-1 h (1.18 Ω s^{-0.5}) and PCF@MnO₂-2 h (1.68 Ω s^{-0.5}). The slight increase in a is in accordance with the fact that the pseudocapacitive reactions are slower than the adsorption-desorption of ions pertaining to the electrical double layer capacitive processes, as well as that the mesopore size is reduced. Despite the increase, the a values of our PCF-based electrodes were remarkably smaller than other MnO₂-based materials (FIG. 11C). Notably, the a value of PCF@MnO₂-2 h was even lower than that of CF (FIG. 11C and FIG. 13), a mostly electrical double layer capacitive (EDLC) material that has fast ion diffusion kinetics. In addition, the a value of PCF@MnO₂-2 h (<2 Ω s^{-0.5}) is ˜3.5 times lower than that of CF@MnO₂-2 h (˜7) Ω s^{-0.5}), highlighting the role of the uniform distributed, randomly oriented, and interconnected mesopores in accelerating electrolyte infiltration and ion diffusion in block copolymer-derived PCFs.

Pseudocapacitive Performance

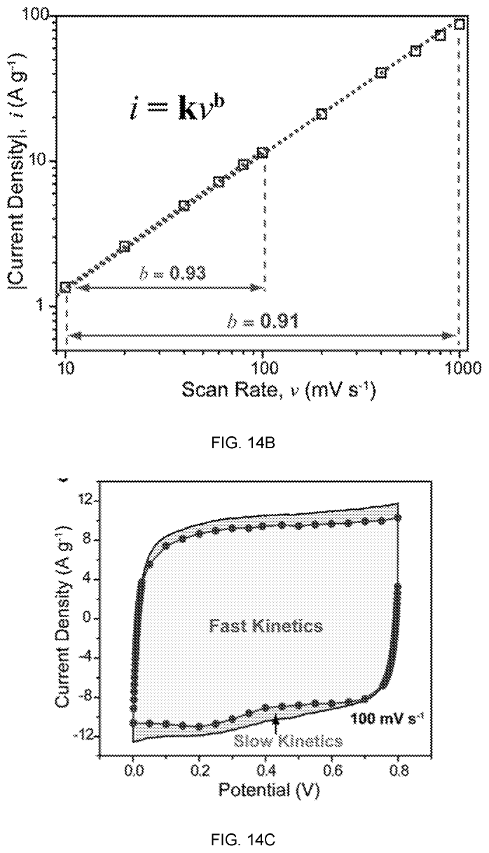

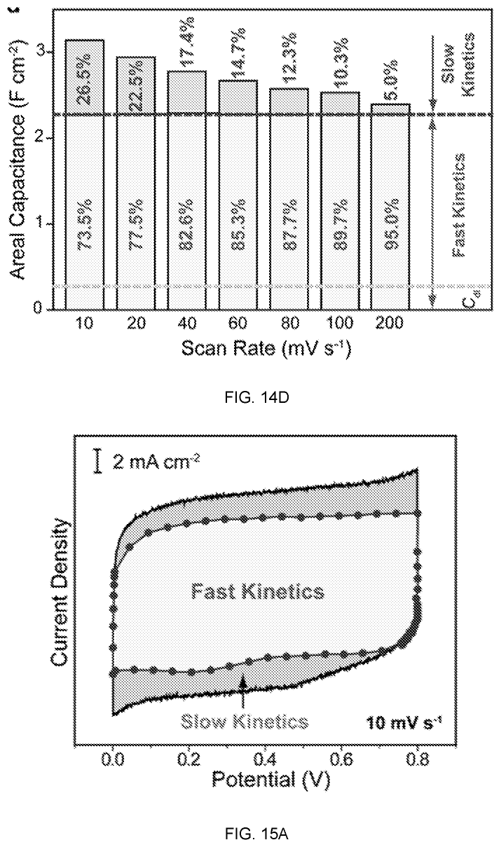

With continuous electron conduction and ultra-low ion diffusion resistivity, PCF@MnO₂-2 h exhibited ultra-fast charge and discharge kinetics. The cyclic voltammograms (CVs) of PCF@MnO₂-2 h were nearly rectangular (FIG. 14A), reflecting the rapid electron and ion transport in the electrode.⁵⁷ The current density of a supercapacitor, i, scales with the scan rate, v, following the relationship of i=kv^{b}. The power-law exponent, b, is an important metric to evaluate the charge-storage kinetics, and b=1 for an ideal supercapacitor. By plotting the logarithm of the absolute cathodic current densities at 0.2 V against the logarithm of scan rates (FIG. 14B), the b-value was calculated to be 0.93 in the scan-rate range of 10-100 mV s⁻¹, approaching that of an ideal capacitor (b=1) and suggesting the ultra-fast charge-storage kinetics. Outstandingly, the b-value decreases only slightly to 0.91 in the range of 10-1000 mV s⁻¹, unambiguously confirming its fast charge-storage kinetics.

The capacitances were further decoupled from fast-kinetic processes and slow-kinetic processes. The decoupling is based on the different contributions of fast and slow kinetics processes in the current density of a CV curve. Briefly, the current density at a fixed potential and a scan rate, i is composed of two terms associated with the scan rate, ν:

$$i = {k}_{1} v + {k}_{2} {v}^{0.5} \qquad ( 1 )$$

where k₁ and k₂ are constants. The first term k₁ν equals the current density contributed from fast-kinetic processes and the second term k₂ν^{0.5} is the current density associated with slow-kinetic (or diffusion-controlled) processes. Dividing ν^{0.5} on both sides of Equation (1) gives:

$$i {v}^{- 0.5} = {k}_{1} {v}^{0.5} + {k}_{2} \qquad ( 2 )$$

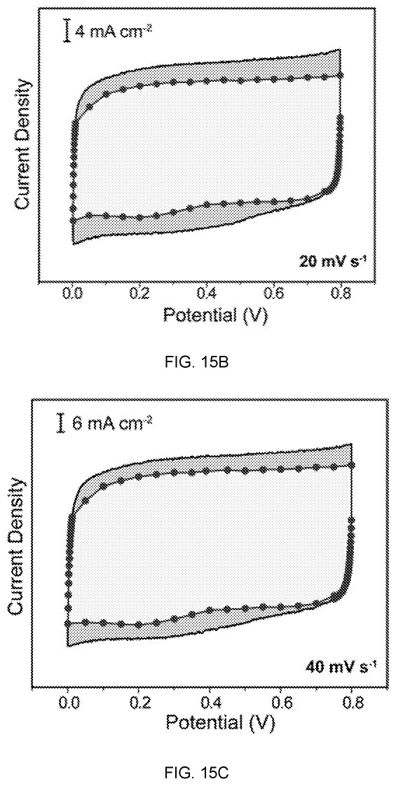

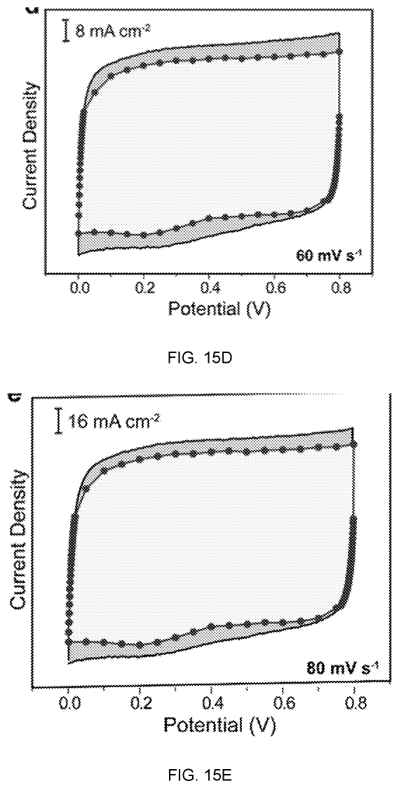

Equation (2) shows that iν^{-0.5} and ν^{0.5} are expected to have a linear relationship, with k₁ and k₂ being the slope and the y-intercept, respectively. Repeating the above step at other scan rates reveals the current density contribution across the potential window and outlines the contribution from the fast-kinetic and slow-kinetic processes. FIG. 14C shows an example of the decoupling of a CV at 100 mV s⁻¹. The capacitive contribution from the fast-kinetic processes (yellow region) clearly dominates that of the slow-kinetic processes (blue region) at all scan rates (FIGS. 14C-14D and FIGS. 15A-15E). The slow-kinetic capacitance decreased with the increasing scan rate. Importantly, the electric double layer capacitance (C_{dl}) contributed only a small fraction in the fast-kinetics region (FIG. 14D, grey dashed line), indicating that the majority of the pseudocapacitance of PCF@MnO₂-2 h is not charge-transfer-limited or diffusion-controlled. The fast kinetics makes PCF@MnO₂ a desirable pseudocapacitive electrode for rapid charge storage and release.

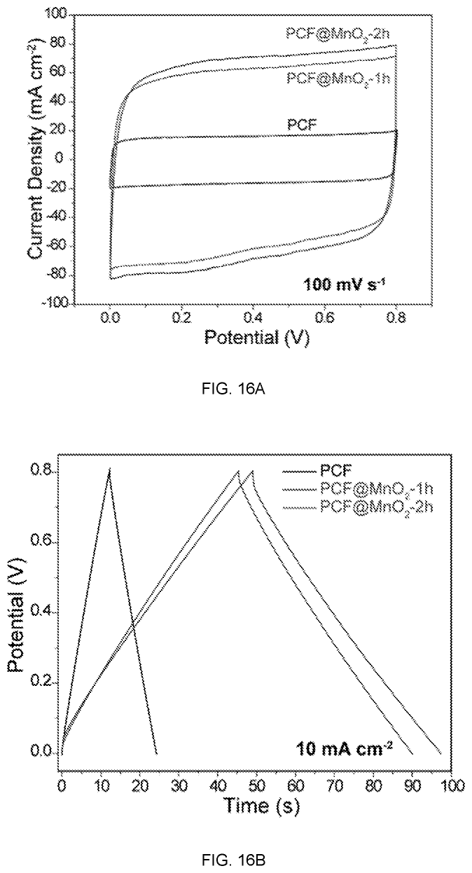

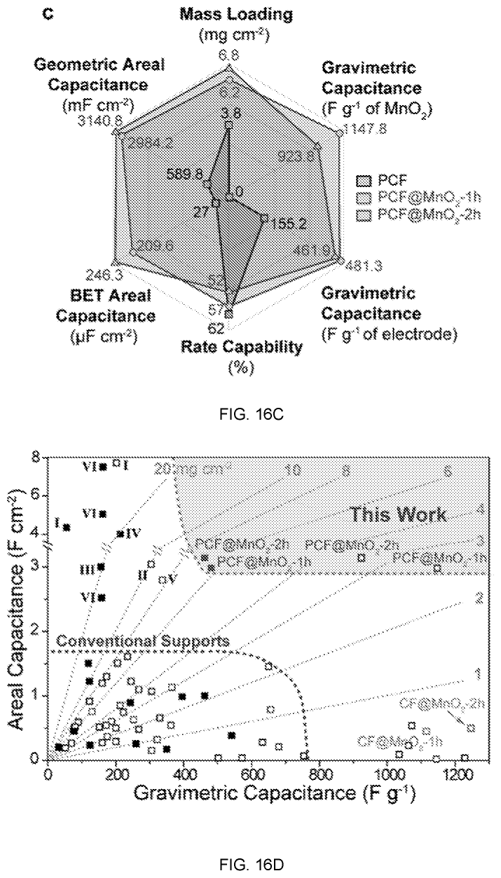

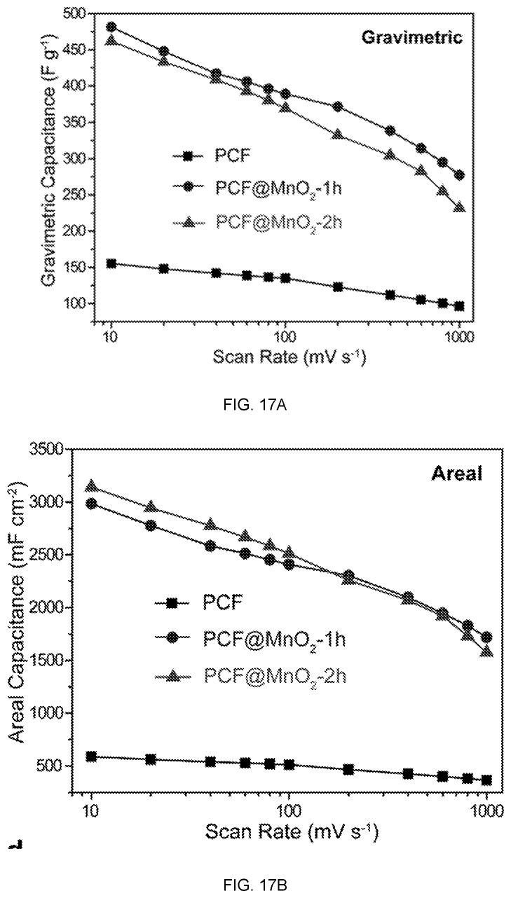

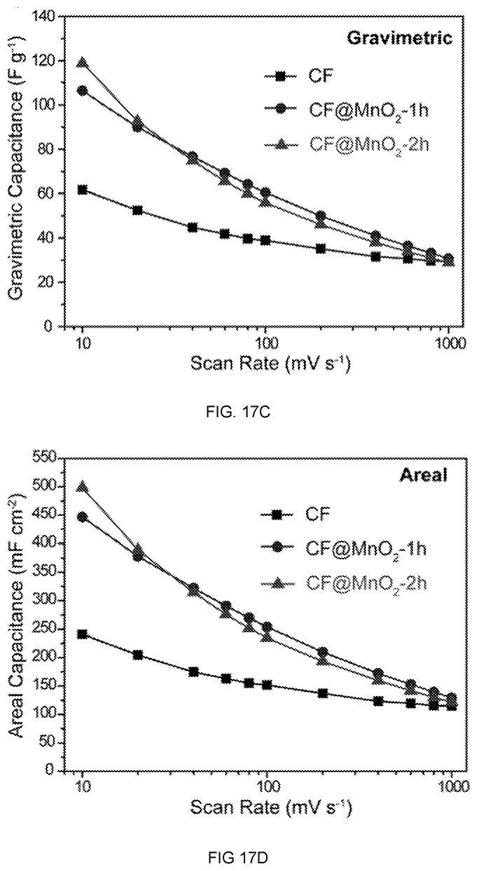

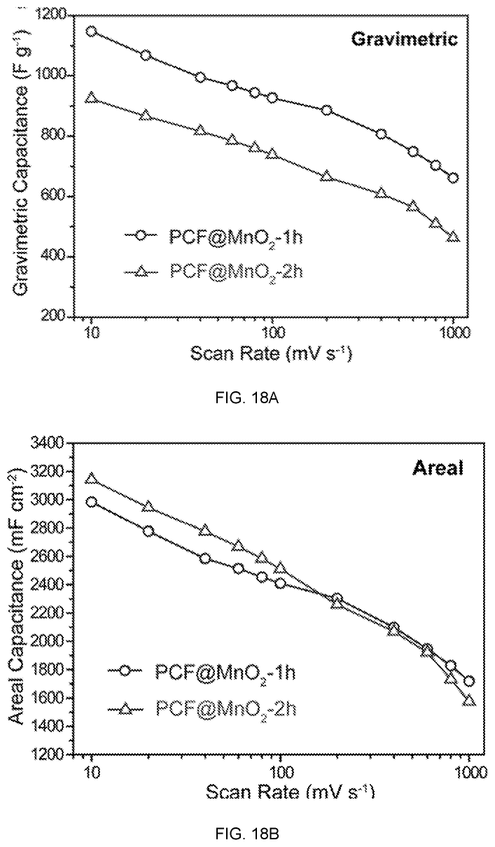

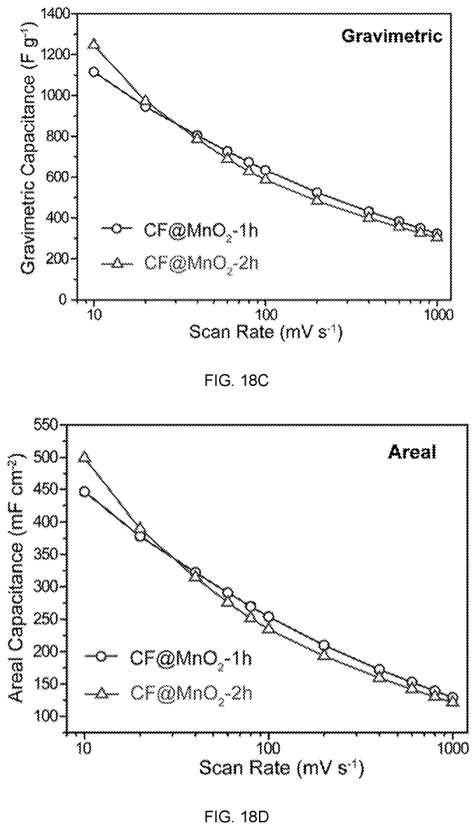

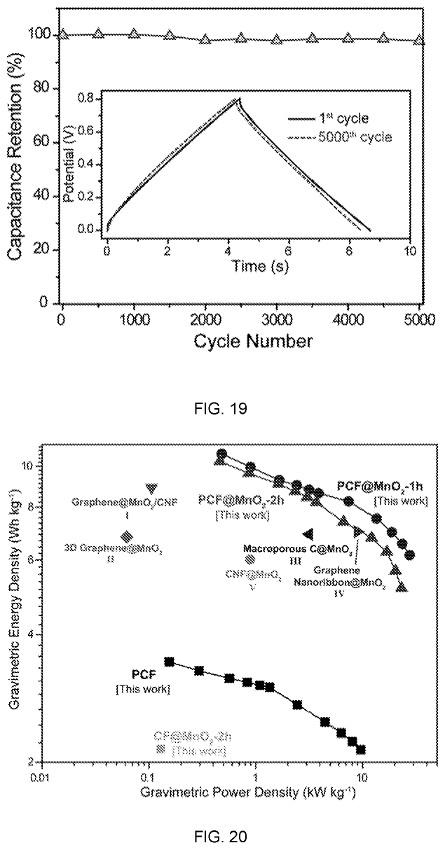

The electrochemical capacitive performance of our carbon fiber electrodes was measured. Among the PCF-based electrodes, PCF@MnO₂-2 h displayed the highest areal capacitance, as shown by the CVs (FIG. 16A) and the galvanostatic charge-discharge (GCD) profiles (FIG. 16B). The negligible deviation of the CVs from the rectangular shape and the isosceles triangular GCD profiles at high 10 mA cm⁻² echoed the fast charge-storage kinetics of PCF@MnO₂. A radar chart (FIG. 16C) summarizes the six figure-of-merits of a pseudocapacitor electrode, i.e., mass loading, gravimetric capacitance normalized to the mass of MnO₂, gravimetric capacitance normalized to the mass of electrode, areal capacitance normalized to geometric surface area, areal capacitance normalized to BET surface area, and rate capability. Due to the lower mass loading of PCF@MnO₂-1 h than that of PCF@MnO₂-2 h, the former achieved higher values in gravimetric capacitance and rate capability. Remarkably, the gravimetric capacitance of PCF@MnO₂-1 h at 10 mV s⁻¹ reached 1148 F g⁻¹ of MnO₂. This value is ˜84% of the theoretical gravimetric capacitance of MnO₂ (1367 F g⁻¹) within a potential window of 0.8 V, even slightly higher than those on the model supports of mesoporous Au^{22,23} and dendritic Ni²⁶, suggesting almost all the MnO₂ loaded on PCFs was accessible to the ions and contributed to the high capacitance. PCF@MnO₂-2 h displayed the highest areal capacitance owing to its highest mass loading. PCF exhibited the best rate capability because it charges/discharges mostly via electrical double layers. Full comparison of the gravimetric, areal, and volumetric capacitances of PCF-based and CF-based electrodes at various scan rates are summarized in FIGS. 17A-17D and FIGS. 18A-18D. Markedly, the gravimetric capacitance and geometric areal capacitance of PCF@MnO₂-2 h outperformed the previously-reported MnO₂ electrodes at comparable mass loadings under similar testing conditions (FIG. 16D). Ideally, with fast electron and ion transport at high mass loadings, both the areal and gravimetric capacitances are expected to be high. However, most reported MnO₂ electrodes have poor areal and/or gravimetric capacitances. In contrast, our PCF-supported MnO₂ electrodes have both high areal and gravimetric capacitances. PCF@MnO₂-2 h was also highly stable, retaining more than 98% of the initial capacitance after 5000 consecutive charge-discharge cycles (FIG. 19)

The Ragone plot (FIG. 20) compares the specific energy and power densities of PCF@MnO₂ with those of the MnO₂ supported on graphene, a star material for supercapacitor electrodes. With a high gravimetric power density of 23.2 kW kg⁻¹ and a high gravimetric energy density of 10.3 Wh kg⁻¹ in the tested range of scan rates, PCF@MnO₂-2 h outperformed the various graphene- and CF-supported MnO₂ electrodes in symmetric pseudocapacitors. The superior capacitive performance signifies that our PCF-supported MnO₂ electrodes have realized both high mass loadings and ultrafast charge transport kinetics.

Discussion

The judiciously designed comparison between our PCFs and conventional CFs proves that PCFs with uniform mesopores are superior carbon supports for addressing the two long-lasting challenges of pseudocapacitors: high mass loading and fast charge transport. Utilizing the concept of block copolymer self-assembly and microphase separation, PCFs provide abundant mesopores with a large surface area for high mass loadings of ultrathin (<2 nm) pseudocapactive materials. On the one hand, the ultrathin pseudocapactive material, along with the continuous fibrous carbon network, renders the composite electrode fast electron transport. On the other hand, the partially filled mesopores provide continuous and wide-open channels for effective ion transport with little diffusion resistance, even at high mass loadings approaching 7 mg cm⁻². The PCF@MnO₂ electrodes show outstanding and balanced gravimetric capacitance, areal capacitance, and rate capability, which outperform other MnO₂-based pseudocapacitive electrodes at comparable mass loadings and testing conditions. Future investigations on the interplays among the polymer molecular weight, mesopore size, mass loading of MnO₂, ion diffusion resistivity and the use of ionic liquid electrolytes⁶⁰ are expected to further optimize the capacitive performance of PCF@MnO₂ and enhance the energy density of the supercapacitors.

This work signifies the great potential of leveraging the disparate and innovative concept of block copolymer microphase separation to design and fabricate mesoporous carbon fiber supports. The highly uniform mesopores can provide for the high loading of guest materials and the efficient transport of ions. The block copolymer-derived PCFs revolutionize the porous carbon supports and are adaptable to a broad range of electrochemical applications including batteries, fuel cells, catalyst supports, and capacitive desalination devices.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

### REFERENCES

1. Salanne M., et al. Efficient storage mechanisms for building better supercapacitors. Nat. Energy 1, 16070 (2016).
2. Pech D., et al. Ultrahigh-power micrometre-sized supercapacitors based on onion-like carbon. Nat. Nanotechnol. 5, 651-654 (2010).
3. Simon P., Gogotsi Y. Materials for electrochemical capacitors. Nat. Mater. 7, 845-854 (2008).
4. Miller J. R., Simon P. Electrochemical capacitors for energy management. Science 321, 651-652 (2008).
5. Wang J.-G., Kang F., Wei B. Engineering of MnO₂-based nanocomposites for high-performance supercapacitors. Prog. Mater. Sci. 74, 51-124 (2015).
6. Hu Z., et al. Al-doped α-MnO₂ for high mass-loading pseudocapacitor with excellent cycling stability. Nano Energy 11, 226-234 (2015).
7. Bélanger D., Brousse T., Long J. W. Manganese oxides: battery materials make the leap to electrochemical capacitors. Interface 17, 49-52 (2008).
8. Lee H. Y., Goodenough J. B. Supercapacitor behavior with KCl electrolyte. J. Solid State Chem. 144, 220-223 (1999).
9. Toupin M., Brousse T., Bélanger D. Charge storage mechanism of MnO₂ electrode used in aqueous electrochemical capacitor. Chem. Mater. 16, 3184-3190 (2004).
10. Balducci A., Belanger D., Brousse T., Long J. W., Sugimoto W. A guideline for reporting performance metrics with electrochemical capacitors: from electrode materials to full devices. J. Electrochem. Soc. 164, A1487-A1488 (2017).
11. Song Y., et al. Ostwald ripening improves rate capability of high mass loading manganese oxide for supercapacitors. ACS Energy Lett. 2, 1752-1759 (2017).
12. Huang Z. H., Song Y., Feng D. Y., Sun Z., Sun X., Liu X. X. High mass loading MnO₂ with hierarchical nanostructures for supercapacitors. ACS Nano 12, 3557-3567 (2018).
13. Wang L., et al. Three-dimensional kenaf stem-derived porous carbon/MnO₂ for high-performance supercapacitors. Electrochim. Acta 135, 380-387 (2014).
14. Chen C., et al. All-wood, low tortuosity, aqueous, biodegradable supercapacitors with ultra-high capacitance. Energy Environ. Sci. 10, 538-545 (2017).
15. Huang M., Li F., Dong F., Zhang Y. X., Zhang L. L. MnO₂-based nanostructures for high-performance supercapacitors. J. Mater. Chem. A 3, 21380-21423 (2015).
16. Hu L., et al. Symmetrical MnO₂-carbon nanotube-textile nanostructures for wearable pseudocapacitors with high mass Loading. ACS Nano 5, 8904-8913 (2011).
17. Hou Y., Cheng Y., Hobson T., Liu J. Design and synthesis of hierarchical MnO₂ nanospheres/carbon nanotubes/conducting polymer ternary composite for high performance electrochemical electrodes. Nano Lett. 10, 2727-2733 (2010).
18. Narubayashi M., Chen Z., Hasegawa K., Noda S. 50-100 μm-thick pseudocapacitive electrodes of MnO₂ nanoparticles uniformly electrodeposited in carbon nanotube papers. RSC Adv. 6, 41496-41505 (2016).
19. Cheng Y., Lu S., Zhang H., Varanasi C. V., Liu J. Synergistic effects from graphene and carbon nanotubes enable flexible and robust electrodes for high-performance supercapacitors. Nano Lett. 12, 4206-4211 (2012).
20. Li L., Raji A.-R. O., Tour J. M. Graphene-wrapped MnO₂-graphene nanoribbons as anode materials for high-performance lithium ion batteries Adv. Mater. 25, 6298-6302 (2013).
21. Forse A. C., et al. Direct observation of ion dynamics in supercapacitor electrodes using in situ diffusion NMR spectroscopy. Nat. Energy 2, 16216 (2017).
22. Lang X., Hirata A., Fujita T., Chen M. Nanoporous metal/oxide hybrid electrodes for electrochemical supercapacitors. Nat. Nanotechnol. 6, 232-236 (2011).
23. Kang J., et al. Electroplated thick manganese oxide films with ultrahigh capacitance. Adv. Energy Mater. 3, 857-863 (2013).
24. Pang S.-C., Anderson M. A., Chapman T. W. Novel electrode materials for thin-film ultracapacitors: comparison of electrochemical properties of sol-gel-derived and electrodeposited manganese dioxide J. Electrochem. Soc. 147, 444-450 (2000).
25. Broughton J. N., Brett M. J. Investigation of thin sputtered Mn films for electrochemical capacitors. Electrochim. Acta 49, 4439-4446 (2004).
26. Sun Z., Firdoz S., Yap E. Y., Li L., Lu X. Hierarchically structured MnO₂ nanowires supported on hollow Ni dendrites for high-performance supercapacitors. Nanoscale 5, 4379-4387 (2013).
27. Ho C.-L., Wu M.-S. Manganese oxide nanowires grown on ordered macroporous conductive nickel scaffold for high-performance supercapacitors. J. Phys. Chem. C 115, 22068-22074 (2011).
28. Liu Y., Zeng Z., Bloom B., Waldeck D. H., Wei J. Stable low-current electrodeposition of α-MnO₂ on superaligned electrospun carbon nanofibers for high-performance energy storage. Small 14, 1703237 (2018).
29. Chen L.-F., Huang Z.-H., Liang H.-W., Guan Q.-F., Yu S.-H. Bacterial-cellulose-derived carbon nanofiber@MnO₂ and nitrogen-doped carbon nanofiber electrode materials: an asymmetric supercapacitor with high energy and power density. Adv. Mater. 25, 4746-4752 (2013).
30. Wang J.-G., Yang Y., Huang Z.-H., Kang F. A high-performance asymmetric supercapacitor based on carbon and carbon-MnO₂ nanofiber electrodes. Carbon 61, 190-199 (2013).
31. Dong X., et al. MnO₂-embedded-in-mesoporous-carbon-wall structure for use as electrochemical capacitors. J. Phys. Chem. B 110, 6015-6019 (2006).
32. Fischer A. E., Pettigrew K. A., Rolison D. R., Stroud R. M., Long J. W. Incorporation of homogeneous, nanoscale MnO₂ within ultraporous carbon structures via self-limiting electroless deposition: implications for electrochemical capacitors. Nano Lett. 7, 281-286 (2006).
33. Lytle J. C., et al. The right kind of interior for multifunctional electrode architectures: carbon nanofoam papers with aperiodic submicrometre pore networks interconnected in 3D. Energy Environ. Sci. 4, 1913-1925 (2011).
34. Bates F. S., Fredrickson G. H. Block copolymer thermodynamics: theory and experiment. Annu. Rev. Phys. Chem. 41, 525-557 (1990).
35. Zhong M., et al. Electrochemically active nitrogen-enriched nanocarbons with well-defined morphology synthesized by pyrolysis of self-assembled block copolymer. J. Am. Chem. Soc. 134, 14846-14857 (2012).
36. Qiang Z., Xia Y., Xia X., Vogt B. D. Generalized synthesis of a family of highly heteroatom-doped ordered mesoporous carbons. Chem. Mater. 29, 10178-10186 (2017).
37. Ruiz R., et al. Density multiplication and improved lithography by directed block copolymer assembly. Science 321, 936-939 (2008).
38. Peinemann K.-V., Abetz V., Simon P. F. W. Asymmetric superstructure formed in a block copolymer via phase separation. Nat. Mater. 6, 992-996 (2007).
39. Sai H., et al. Hierarchical porous polymer scaffolds from block copolymers. Science 341, 530-534 (2013).
40. Song Y., et al. Copolymer-Templated Synthesis of Nitrogen-Doped Mesoporous Carbons for Enhanced Adsorption of Hexavalent Chromium and Uranium. ACS Appl. Nano Mater. 1, 2536-2543 (2018).
41. Yan K., et al. Design and preparation of highly structure-controllable mesoporous carbons at the molecular level and their application as electrode materials for supercapacitors. J. Mater. Chem. A 3, 22781-22793 (2015).
42. Zhou Z., Liu T., Khan A. U., Liu G. Block Copolymers Based Hierarchical Porous Carbon Fibers. Sci. Adv., DOI: 10.1126/sciadv.aau6852 (2019).
43. Gomez E. D., Das J., Chakraborty A. K., Pople J. A., Balsara N. P. Effect of Cross-Linking on the Structure and Thermodynamics of Lamellar Block Copolymers. Macromolecules 39, 4848-4859 (2006).
44. Wilbur J. D., Gomez E. D., Ellsworth M. W., Garetz B. A., Balsara N. P. Thermoreversible Changes in Aligned and Cross-Linked Block Copolymer Melts Studied by Two Color Depolarized Light Scattering. Macromolecules 45, 7590-7598 (2012).
45. Lee S.-W., et al. Structural changes in reduced graphene oxide upon MnO₂ deposition by the redox reaction between carbon and permanganate ions. J. Phys. Chem. C 118, 2834-2843 (2014).
46. Zhao X., et al. Incorporation of manganese dioxide within ultraporous activated graphene for high-performance electrochemical capacitors. ACS Nano 6, 5404-5412 (2012).
47. Chigane M., Ishikawa M. Manganese oxide thin film preparation by potentiostatic electrolyses and electrochromism. J. Electrochem. Soc. 147, 2246-2251 (2000).
48. Xia H., Wang Y., Lin J., Lu L. Hydrothermal synthesis of MnO₂/CNT nanocomposite with a CNT core/porous MnO₂ sheath hierarchy architecture for supercapacitors. Nanoscale Res. Lett. 7, 33 (2012).
49. Zhu S., et al. Structural directed growth of ultrathin parallel birnessite on β-MnO₂ for high-performance asymmetric supercapacitors. ACS Nano 12, 1033-1042 (2018).
50. Zhai T., et al. A new benchmark capacitance for supercapacitor anodes by mixed-valence sulfur-doped V₆O₁₃₋ₓ. Adv. Mater. 26, 5869-5875 (2014).
51. Lei C., Amini N., Markoulidis F., Wilson P., Tennison S., Lekakou C. Activated carbon from phenolic resin with controlled mesoporosity for an electric double-layer capacitor (EDLC) J. Mater. Chem. A 1, 6037-6042 (2013).
52. Oyedotun K. O., Madito M. J., Bello A., Momodu D. Y., Mirghni A. A., N. Manyala. Investigation of graphene oxide nanogel and carbon nanorods as electrode for electrochemical supercapacitor. Electrochim. Acta 245, 268-278 (2017).
53. Hatzell K. B., et al. Composite manganese oxide percolating networks as a suspension electrode for an asymmetric flow capacitor. ACS Appl. Mater. Interfaces 6, 8886-8893 (2014).
54. Yuan Y., et al. The influence of large cations on the electrochemical properties of tunnel-structured metal oxides. Nat. Commun. 7, 13374 (2016).
55. Mai L., et al. Fast ionic diffusion-enabled nanoflake electrode by spontaneous electrochemical pre-Intercalation for high-performance supercapacitor. Sci. Rep. 3, 1718 (2013).
56. Zhang J., et al. Interior design of three-dimensional CuO ordered architectures with enhanced performance for supercapacitors. J. Mater. Chem. A 4, 6357-6367 (2016).
57. Zhang F., et al. Multiscale pore network boosts capacitance of carbon electrodes for ultrafast charging. Nano Lett. 17, 3097-3104 (2017).
58. Shi K., Giapis K. P. Scalable fabrication of supercapacitors by nozzle-free electrospinning. ACS Appl. Energy Mater. 1, 296-300 (2018).
59. Shi K., Zhitomirsky I. Asymmetric supercapacitors based on activated-carbon-coated carbon nanotubes. ChemElectroChem 2, 396-403 (2015).
60. Zhang X., et al. High performance asymmetric supercapacitor based on MnO₂ electrode in ionic liquid electrolyte. J. Mater. Chem. A 1, 3706-3712 (2013).
61. Zhou Z., Liu G. Controlling the pore size of mesoporous carbon thin films through thermal and solvent annealing. Small 13, 1603107 (2017).
62. Wang J., Polleux J., Lim J., Dunn B. Pseudocapacitive contributions to electrochemical energy storage in TiO₂ (anatase) nanoparticles. J. Phys. Chem. C 111, 14925-14931 (2007).
63. Augustyn V., et al. High-rate electrochemical energy storage through Li⁺ intercalation pseudocapacitance. Nat. Mater. 12, 518-522 (2013).
64. Cheng Y., Lu S., Zhang H., Varanasi C. V., Liu J. Synergistic effects from graphene and carbon nanotubes enable flexible and robust electrodes for high-performance supercapacitors. Nano Lett. 12, 4206-4211 (2012).
65. He Y., et al. Freestanding three-dimensional graphene/MnO₂ composite networks as ultralight and flexible supercapacitor electrodes. ACS Nano 7, 174-182 (2013).
66. Wang L., et al. Three-dimensional kenaf stem-derived porous carbon/MnO₂ for high-performance supercapacitors. Electrochim. Acta 135, 380-387 (2014).
67. Liu M., Tjiu W. W., Pan J., Zhang C., Gao W., Liu T. One-step synthesis of graphene nanoribbon-MnO₂ hybrids and their all-solid-state asymmetric supercapacitors. Nanoscale 6, 4233-4242 (2014).
68. Wang J.-G., Yang Y., Huang Z.-H., Kang F. A high-performance asymmetric supercapacitor based on carbon and carbon-MnO₂ nanofiber electrodes. Carbon 61, 190-199 (2013).

1. An electrode material comprising:
(i) a porous carbon fiber support comprising a plurality of mesoscale pores having an internal surface and an average pore width of about 2 nm to about 200 nm;
(ii) a metal oxide layer on at least the internal surface of the mesoscale pores.

2. The electrode material according to claim 1, wherein the porous carbon fiber support comprises a plurality of microscale pores having an average pore width of about 0.1 nm to about 2 nm; and
wherein the metal oxide layer fills the microscale pores.

3. The electrode material according to claim 1, wherein the porous carbon fiber support has a Brunauer-Emmett-Teller (BET) surface area of about 100 m² g⁻¹ to about 1000 m² g⁻¹.

4. The electrode material according to claim 1, wherein the plurality of mesoscale pores have a volume of about 0.1 cm³ g⁻¹ to about 1.0 cm³ g⁻¹ when measured according to the Physisorption Isotherm Method.

5. The electrode material according to claim 2, wherein the plurality of microscale pores have a volume of about 0.05 cm³ g⁻¹ to about 0.5 cm³ g⁻¹ when measured according to the Physisorption Isotherm Method.

6. The electrode material according to claim 1, wherein the porous carbon fiber support is free or essentially free of macroscale pores having an average pore width of about 500 nm, about 1 micron, or greater; or
wherein the porous carbon fiber support comprises a volume of macroscale pores of about 0.01 cm³ g⁻¹ or less when measured according to the Physisorption Isotherm Method.

7. The electrode material according to claim 6, wherein the metal oxide layer comprises manganese oxide.

8. The electrode material according to claim 6, wherein the metal oxide layer comprises a metal oxide selected from the group consisting of manganese oxide, nickel oxide, cobalt oxide, chromium oxide, iron oxide, copper oxide, zinc oxide, molybdenum oxide, tungsten oxide, aluminum oxide, titanium oxide, and a combination thereof.

9. The electrode material according to claim 6, wherein the metal oxide layer has an average thickness of about 0.2 nm to about 5 nm.

10. The electrode material according to claim 6, wherein the electrode material has a Brunauer-Emmett-Teller (BET) surface area of about 100 m² g⁻¹ to about 250 m² g⁻¹ when measured according to the Physisorption Isotherm Method.

11. The electrode material according to claim 6, wherein the electrode material has a total mass loading of carbon fiber and metal oxide of 5 mg cm⁻² to 15 mg cm⁻² when measured according to the Mass Loading Method.

12. The electrode material according to claim 11, wherein the metal oxide is at least 40% of the total mass loading when measured according to the Mass Loading Method.

13. The electrode material according to claim 1, wherein the mesoscale pores having an average pore width of about 10 nm to about 15 nm and a pore volume of about 0.5 cm³ g⁻¹ to about 1.0 cm³ g⁻¹ when measured according to the Physisorption Isotherm Method;
wherein the metal oxide layer comprises a manganese oxide layer having an average thickness of about 0.5 nm to about 2.0 nm;
wherein the electrode material has a total mass loading of carbon fiber and metal oxide of 5 mg cm⁻² to 15 mg cm⁻² when measured according to the Mass Loading Method; and
wherein the manganese oxide is at least 35% of the total mass loading.

14. A method of making an electrode material according to claim 1, the method comprising:
providing a block copolymer comprising a carbon precursor block and a degradable block, wherein the block copolymer phase separates into first domains rich in the carbon precursor block and second domains rich in the degradable block;
heating the block copolymer to a first elevated temperature for a first period of time to induce phase separation and pretreat the carbon precursor block;
applying one or more of an acid, abase, and a second elevated temperature in an inert or oxidizing atmosphere to convert the carbon precursor block into carbon and to decompose the degradable block to produce a porous carbon fiber;
depositing metal oxide layer onto a surface of the porous carbon fiber to form the electrode material.

15. The method according to claim 14, wherein the carbon precursor block comprises an acrylic block, a cellulosic block, a vinylidene chloride block, a phenolic block, a rayon block, an imide block and a combination thereof; and
wherein the degradable block is degradable via pyrolysis, photolysis, hydrolysis, or a combination thereof.

16. The method according to claim 14, wherein the carbon precursor block comprises polyacrylonitrile (PAN) and derivatives thereof with other vinyl ester comonomers such as vinyl acetate, methacrylate, and methyl methacrylate; and
wherein the degradable block is degradable via pyrolysis, photolysis, hydrolysis, or a combination thereof.

17. The method according to claim 14, wherein the carbon precursor block comprises a rayon block; and
wherein the degradable block is degradable via Pyrolysis, photolysis, hydrolysis, or a combination thereof.

18. The method according to claim 14, wherein the carbon precursor block comprises one or more blocks selected from the group consisting of phenolic polymers, polyacenephthalene, polyamide, polyphenylene, poly-p-phenylene benzobisthiazole (PBBT), polybenzoxazole, polybenzimidazole, polyvinyl alcohol, polyvinylidene chloride, polystyrene, and a combination thereof; and
wherein the degradable block is degradable via Pyrolysis, photolysis, hydrolysis, or a combination thereof.

19. (canceled)

20. (canceled)

21. (canceled)

22. The method according to claim 14, wherein the metal oxide is deposited by electrodeposition, preganation, or a combination thereof.

23. (canceled)

24. A device comprising an electrode comprising a material according to claim 1, wherein the device comprises a supercapacitor, battery, fuel cell, or other energy conversion or energy storage device.

25. (canceled)
